(19) United States
(12) Patent Application Publication
(10) Pub. No.: US 2026/0289079 A1
(43) Pub. Date: Sep. 24, 2026

(54) SYSTEM

(71) Applicant: SoftBank Group Corp., Tokyo (JP)

(72) Inventor: Yu KAZUMI, Tokyo (JP)

(73) Assignee: SoftBank Group Corp., Tokyo (JP)

(21) Appl. No.: 19/562,815

(22) Filed: Mar. 11, 2026

(30) Foreign Application Priority Data
Mar. 19, 2025 (JP) 2025-044475

(51) Int. Cl. G06F 40/166; G06F 40/40

(52) U.S. Cl. CPC G06F 40/166; G06F 40/40

(57) ABSTRACT

A system includes a processor that is configured to receive an input from a user, preprocess the input, generate a prompt sentence for instructing a generative AI model to generate a text expression, input the prompt sentence to the generative AI model, translate text generated by the generative AI model, correct the translated text, store the corrected text in a database, and provide the stored text to the user.

### CROSS-REFERENCE TO RELATED APPLICATION

This application is based on and claims priority under 35 USC 119 from Japanese Patent Application No. 2025-044475 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional text communication systems that use generative AI models suffer from several problems. First, such systems often accept user input and directly pass the input text to a generative AI model without performing sufficient preprocessing or structured prompting, which can result in unstable or inappropriate outputs. Second, even when the generative AI model generates text appropriately, conventional systems do not always provide an integrated processing flow including translation, correction, and storage, so that the final text provided to the user may contain linguistic errors, unsuitable tone, or inconsistent style. Third, conventional systems generally treat the user's emotional state as an implicit factor, and do not systematically control prompt generation or text generation based on the emotion of the user. As a result, the systems may return responses that fail to calm or support the user, or that inadvertently intensify negative emotions. Therefore, there is a need for a system that can systematically manage the entire flow from user input, preprocessing, prompt generation, execution of a generative AI model, translation, correction, and storage, and that can further take into account the user's emotional state in order to generate appropriate text for communication.

### SUMMARY

In order to solve the above problems, according to one aspect of the present invention, there is provided a system comprising a processor, wherein the processor is configured to receive an input from a user, preprocess the input, generate a prompt sentence for instructing a generative AI model to generate a text expression, input the prompt sentence to the generative AI model, translate text generated by the generative AI model, correct the translated text, store the corrected text in a database, and provide the stored text to the user. By performing preprocessing and structured prompt generation, the processor can supply a well-defined instruction to the generative AI model so that the generated text expression is more stable and suitable for the intended task. By performing translation and correction of the generated text, the processor can adjust grammar, vocabulary, and tone to generate a refined expression in a desired language. Furthermore, by storing the corrected text in the database and providing the stored text to the user, the system can maintain a history of refined text expressions for later reference or reuse. In some embodiments, the processor is configured to generate the prompt sentence to instruct the generative AI model to generate text in response to an input prompt by using a neural network, thereby enabling flexible and high-quality text generation based on a neural network architecture. In other embodiments, the processor is configured to generate the prompt sentence in consideration of an emotional state of the user and to instruct generation of text according to the emotional state, so that the system can produce text that is adapted to the user's current emotions, for example by softening expressions when the user is angry or by providing supportive language when the user is sad.

The term “system” refers to an arrangement including at least one processor and, optionally, one or more memories, communication interfaces, and storage devices, configured to execute the processing operations described in the claims.

The term “processor” refers to any hardware component or combination of hardware components, such as a CPU, GPU, ASIC, FPGA, or other processing circuitry, that executes instructions to perform the functions recited in the claims.
The term “user” refers to a human operator or an entity that provides input to the system and receives output text generated, processed, or provided by the system.
The term “input” refers to any data, including text or text-related information, that is provided by the user to the system for processing.
The term “preprocess” refers to performing one or more operations on the input before supplying it to a generative AI model, such operations including at least one of normalization, cleaning, tokenization, segmentation, language detection, anonymization, or formatting.
The term “prompt sentence” refers to a text or text-like instruction generated by the processor and supplied to a generative AI model to control or guide the generation of a text expression.
The term “generative AI model” refers to a machine learning model, including but not limited to a neural network-based model, that generates text in response to an input prompt or context.
The term “text expression” refers to any sequence of characters, words, or sentences generated or processed by the system for the purpose of communication.
The term “translate” refers to converting text from a first natural language into a second natural language while preserving at least part of the original meaning.
The term “translated text” refers to text that results from performing translation on text generated by the generative AI model.
The term “correct” refers to modifying text, including translated text, to improve at least one of grammar, spelling, vocabulary, style, politeness level, or consistency with a desired tone or context.
The term “corrected text” refers to text obtained after the processor performs correction on translated text or other generated text.
The term “database” refers to any structured or semi-structured storage system, including relational databases, NoSQL databases, or other data stores, in which the corrected text and related information are stored.
The term “stored text” refers to corrected text and possibly associated metadata that have been written into the database by the processor.
The term “provide” refers to outputting, transmitting, or otherwise making available text from the system to the user, including via a terminal, user interface, or communication network.
The term “neural network” refers to a computational model composed of interconnected nodes or layers that processes input data to generate outputs, and that is trainable using machine learning techniques such as supervised, unsupervised, or reinforcement learning.
The term “input prompt” refers to text or data supplied to a generative AI model, including a prompt sentence generated by the processor, that conditions or guides the model to generate corresponding output text.
The term “emotional state of the user” refers to an affective condition of the user, such as anger, sadness, joy, anxiety, or calmness, which may be inferred from user input or other signals and used to control prompt generation or text generation.
The term “text according to the emotional state” refers to text generated under instructions that take into account the emotional state of the user, such that at least one of content, tone, style, or intensity is adapted to that emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

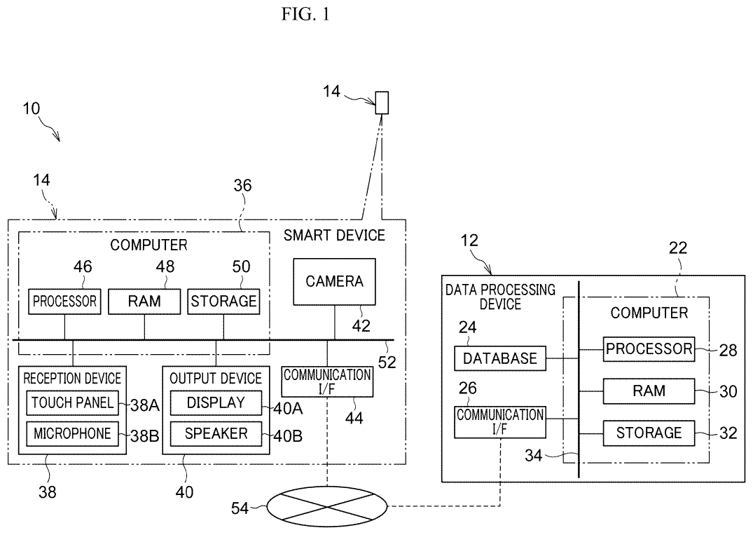

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

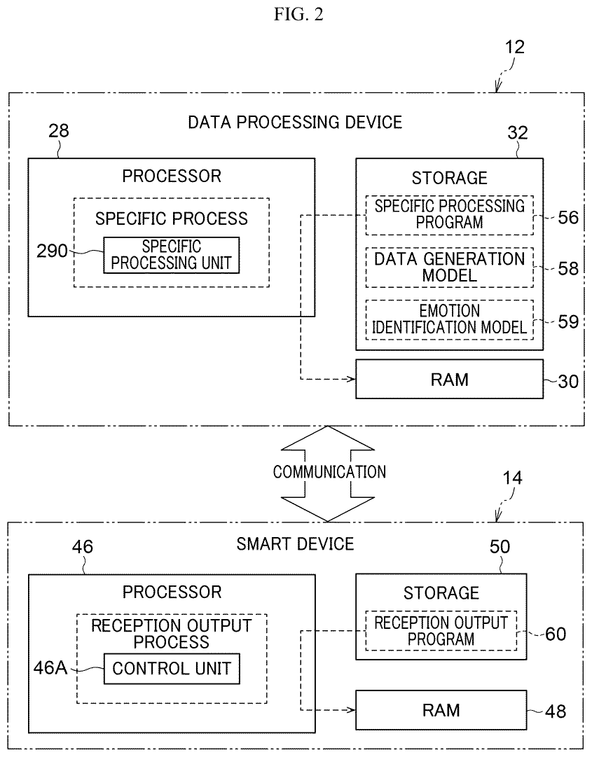

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Natural language processing systems that perform translation or rewriting using machine learning models often treat user input text as a flat sequence of characters without adequately modeling the user's emotional state or the desired emotional intensity of the output. As a result, conventional systems frequently produce translations or rewritten expressions that are formally correct but misaligned with a user's intended emotional nuance, for example outputting a strongly worded sentence when the user intends a mild tone. Furthermore, in many existing architectures, a server simply forwards user input to a generative model and returns the model's raw output, without performing structured preprocessing, without constructing task-specific prompt sentences, and without managing the lifecycle of generated results as reusable, queryable history data. From a computer technology standpoint, this leads to several concrete problems. First, the absence of systematic preprocessing and prompt construction on the server side prevents optimal conditioning of a generative AI model and results in unstable output quality, thereby degrading the reliability of server-side natural language services. Second, the lack of explicit control information such as translation instructions, emotion intensity adjustment instructions, and output format constraints embedded in a prompt sentence forces downstream components or human users to perform repeated corrections, increasing computational load and network traffic. Third, conventional systems do not tightly integrate server-side history management with model interaction, so generated text outputs are not stored as structured data linked with the originating prompt sentences and user metadata, which impairs retrieval efficiency, traceability, and the ability to reuse prior results for subsequent processing.

Additionally, some existing solutions attempt to handle translation and tone adjustment in the client device, resulting in duplicated logic across heterogeneous terminals and inconsistent behavior depending on client environment. This fragmentation complicates maintenance and hinders optimization of the overall pipeline, because key functions such as preprocessing, model invocation, correction, and storage are dispersed. There is therefore a need for a server-centric architecture that centralizes these functions in a processor configured to perform specific data transformations and control operations, so that generative AI models can be used more deterministically and efficiently within a networked system. Accordingly, there is a demand for a technical solution that improves computer operation by: (i) standardizing and structuring input text through server-side preprocessing; (ii) automatically generating prompt sentences that explicitly encode translation and emotion adjustment instructions for a generative AI model; (iii) orchestrating model interactions, including iterative corrections, in a programmatic manner; and (iv) storing corrected text outputs and related management information as structured history in a storage medium, thereby enhancing the controllability, reproducibility, and efficiency of server-based natural language processing services.

The specific processing by the specific processing unit 290 of the data processing device 12 in Example 1 is realized by the following means.

The present invention provides a server comprising a processor configured to receive, from a terminal, input information including character information that expresses an emotion of a user; to perform, on the input information, preprocessing including at least a character string normalization process, an unnecessary character removal process, and a language determination process so as to generate preprocessed character information; to generate, on the basis of the preprocessed character information and information relating to an emotional state of the user, a prompt sentence to be used as input to a generative AI model, the prompt sentence including at least a translation instruction and an emotion intensity adjustment instruction; to transmit the prompt sentence to an external processing apparatus that executes the generative AI model and to acquire a text output generated by the generative AI model in response to the prompt sentence; to perform correction processing on the text output to generate corrected text information, the correction processing including at least a translation process to a target language and an emotion intensity adjustment process corresponding to the emotional state of the user; to store, in a storage medium as structured data, the corrected text information in association with the input information and management information relating to the prompt sentence; and to provide the corrected text information to the user by acquiring the corrected text information from the storage medium on the basis of a retrieval condition and transmitting the corrected text information to the terminal. This enables the server to centrally control preprocessing, prompt sentence generation, generative AI model interaction, and structured history management in a manner that improves the determinism, efficiency, and emotional fidelity of text generation and translation processes executed by computer resources.

The term “system” refers to an arrangement of one or more computing devices, communication interfaces, and storage media that cooperate to execute the functions described in the claims.

The term “processor” refers to hardware circuitry, such as a central processing unit, a graphics processing unit, a digital signal processor, or a combination thereof, configured to execute instructions and perform arithmetic and logical operations.
The term “terminal” refers to an information processing device operated by a user, such as a mobile device, a personal computer, or another client device, that transmits input information to the server and receives output information from the server.
The term “user” refers to a human operator or an entity that provides input information to the system through the terminal and receives text information generated by the system.
The term “input information” refers to data received from the terminal, including at least character information that expresses an emotion of the user and optional metadata such as language or control parameters.
The term “character information” refers to textual data composed of one or more characters, symbols, or code points that can be processed by the processor.
The term “emotion” refers to an affective state or feeling, such as anger, sadness, joy, or fear, that is expressed or implied in the character information provided by the user.
The term “emotional state” refers to a condition of the user's emotion, including at least a type of emotion and optionally a degree or intensity of the emotion.
The term “preprocessing” refers to a set of operations performed on the input information prior to submission to a generative AI model, including one or more of normalization, removal of unnecessary characters, language determination, and other data cleaning or structuring.
The term “character string normalization process” refers to an operation that converts the character information into a standardized representation, including at least unifying encodings, normalizing character forms, and harmonizing spacing or punctuation.

The term “unnecessary character removal process” refers to an operation that detects and deletes characters or sequences that are not needed for intended processing, such as control codes, redundant whitespace, or extraneous symbols.

The term “language determination process” refers to an operation that analyzes the input information to identify or verify a natural language associated with the character information.
The term “preprocessed character information” refers to character information that has been subjected to the preprocessing operations so that it is in a format suitable for use as a basis for prompt sentence generation.
The term “prompt sentence” refers to a text instruction or set of text instructions provided as input to a generative AI model, the instruction including at least a description of a requested task and control conditions for generating a text output.
The term “translation instruction” refers to part of a prompt sentence that directs the generative AI model to convert text from a source language into a target language.
The term “emotion intensity adjustment instruction” refers to part of a prompt sentence that directs the generative AI model to adjust the strength or degree of emotion expressed in a text.
The term “generation conditions” refers to one or more parameters or constraints included in a prompt sentence that specify how the generative AI model is to perform a generation process, such as style, tone, or temperature-like behavior.
The term “output format conditions” refers to one or more parameters or constraints included in a prompt sentence that specify a desired structure or format of the text output, such as language, style, or the absence of auxiliary explanations.
The term “generative AI model” refers to a machine learning model, such as a neural network-based language model, configured to generate text output in response to an input prompt sentence.
The term “external processing apparatus” refers to a computing system separate from the server that executes the generative AI model and returns a text output in response to a prompt sentence transmitted by the server.
The term “text output” refers to text generated by the generative AI model in response to a prompt sentence and acquired by the processor for further processing.
The term “correction processing” refers to one or more operations applied to the text output in order to modify, refine, or adjust the content, including at least translation to a target language and adjustment of emotion intensity.
The term “corrected text information” refers to text information that results from applying the correction processing to the text output and that is suitable for provision to the user.
The term “translation process to a target language” refers to an operation that converts text from a source language into a desired target language according to the instructions or configuration of the system.
The term “emotion intensity adjustment process” refers to an operation that modifies the strength, degree, or nuance of an emotion expressed in text, for example by softening a strong expression or amplifying a mild expression.
The term “neural network type generation processing” refers to a processing method in which a neural network model, such as a deep learning model, generates text output based on patterns learned from training data and conditioned on a prompt sentence.
The term “second prompt sentence” refers to a subsequent prompt sentence generated using previously obtained text output as input, the subsequent prompt sentence being used to request further modification or refinement of the text output by the generative AI model.
The term “modified text” refers to text generated by the generative AI model in response to the second prompt sentence, in which at least one of emotional strength, writing style, and politeness level is automatically adjusted.
The term “writing style” refers to characteristics of text such as formality, directness, complexity, or narrative style, which can be controlled or changed by the system.
The term “politeness level” refers to a degree of politeness or formality reflected in text, including but not limited to casual, neutral, and polite modes of expression.
The term “storage medium” refers to a physical or logical storage resource, such as a magnetic disk, solid state drive, optical disk, or memory device, capable of recording and retaining data.
The term “structured data” refers to data organized according to a predetermined schema, such as records with defined fields for input information, corrected text information, prompt sentence information, and timestamps.
The term “management information relating to the prompt sentence” refers to data associated with a prompt sentence, including at least identifiers, timestamps, parameter settings, and references linking the prompt sentence to corresponding input and output texts.
The term “retrieval condition” refers to one or more criteria, such as a user identifier, time range, keyword, or record identifier, used by the processor to search the storage medium for particular corrected text information.
The term “history management” refers to a function in which generated and corrected text information, along with related input and prompt data, is stored and later retrieved as historical records for reuse, analysis, or display to the user.

In one embodiment, a server cooperates with at least one terminal operated by a user to implement the claimed system. The server includes at least one processor, a main memory, one or more network interfaces, and a non-volatile storage medium such as a solid state drive. The server executes an operating system such as a general-purpose server operating system and application software including a web server module, an application logic module, and a database management module. The terminal includes a processor, a display, an input interface such as a touch panel or keyboard, a communication interface, and a memory storing a client application or a web browser. The user operates the terminal to input text expressing an emotional state and to receive corrected text information returned from the server.

The server executes a program that implements the functional units corresponding to the elements recited in the claims. The server provides an application programming interface endpoint accessible from the terminal via a communication network. The terminal transmits input information to the server using a request message, and the server processes this information using specific data structures and algorithms as described below.
The server uses an internal data structure, for example a record or object, to represent input information. This record may contain fields such as an input text string, a user identifier, a source language code, a target language code, and one or more flags representing desired emotion intensity adjustment. The server stores such records temporarily in main memory and logs metadata to a log file in the storage medium.
The server performs preprocessing on the input text using the processor and software modules written in a high-level programming language such as a scripting language or a systems language. The server normalizes the character string by converting it to a standard encoding such as UTF-8, by converting variant forms of characters to a canonical form, and by harmonizing line endings and spacing. The server removes unnecessary characters such as control codes, repeated whitespace, or unsupported symbols using regular expression processing or deterministic parsing routines. The server determines a language of the input text by computing character n-gram frequencies or by applying a statistical language detection library. These preprocessing operations transform the raw input data into preprocessed character information that is robust against noise and inconsistencies. By reducing variability at this stage, the server improves the stability and convergence behavior of the subsequent generative AI model processing, thereby improving overall system performance.
The server constructs a prompt sentence that will be supplied to a generative AI model. The server maintains in memory a prompt template that describes an instruction sequence in natural language. The server fills the template with the preprocessed text and parameters describing the emotional state of the user. In one example, the server generates a prompt sentence of the following form:
“Act as a bilingual emotional expression assistant. Translate the following sentence from English into natural Japanese. Then soften the emotional intensity so that the anger feels mild. Output only the final Japanese sentence, without any explanation. Sentence: ‘I am angry’.”

In another example, the server generates a prompt sentence of the following form:
“Translate the following English sentence into Japanese and adjust the emotional intensity from strong to slightly weak. Return only the final Japanese sentence: I am angry.”
   The server can vary the content of the prompt sentence according to predetermined rules stored as configuration data. For example, the server can insert a directive to use polite style, to avoid slang, or to maintain specific domain terminology. The server embeds generation conditions and output format conditions into the prompt sentence so that the generative AI model performs a specific, constrained generation task rather than open-ended text generation. This explicit conditioning reduces unnecessary token generation and results in faster response time and lower communication load because fewer iterative corrections are needed.
   The server communicates with an external processing apparatus that executes the generative AI model. The external apparatus may implement a neural network-based language model, such as a transformer architecture with multiple layers of self-attention, feed-forward networks, and layer normalization units. The generative AI model internally tokenizes the prompt sentence, maps tokens to embedding vectors, and applies a sequence of matrix multiplications and non-linear activation functions to compute attention weights and hidden representations. The model then predicts each subsequent token in the output sequence using a softmax output layer. The server configures parameters such as maximum output length, sampling temperature, and top-k or top-p sampling thresholds by including instructions in the prompt sentence or by specifying metadata in a request message. Because the server standardizes prompts and tightly bounds model parameters, the generative process becomes more deterministic and less prone to undesired drift, which is a technical improvement over naive use of generative models.
   The generative AI model is trained in advance using a training corpus consisting of parallel texts in multiple languages and examples of emotionally annotated sentences. The external apparatus uses supervised learning and reinforcement-style fine-tuning to adjust model weights. During training, the apparatus computes a loss function such as cross-entropy between predicted tokens and ground-truth tokens, and updates weights by backpropagation and stochastic gradient descent or a variant such as Adam. In some embodiments, the training procedure includes data augmentation that artificially varies emotional intensity expressions, so that the model learns nuanced mappings between strong and mild emotional forms. This training enables the deployed model to follow emotion adjustment instructions embedded in the prompt sentence with greater accuracy.
   The server receives the text output of the generative AI model and treats the output as an intermediate representation. The server verifies that the output matches the requested language using language detection heuristics. If the output does not satisfy language or format conditions, the server can initiate a further correction round by constructing a second prompt sentence that explicitly instructs the model to correct the deficiencies. For example, the server can generate a prompt sentence such as:
“Adjust the emotional intensity of the following Japanese sentence so that the feeling is mild and polite. Return only the corrected Japanese sentence. Sentence: I am angry.”
   The server then supplies the generated Japanese sentence from the first round as part of this second prompt sentence. By explicitly separating translation and emotion adjustment stages, and by automating the generation of multi-stage prompts, the server achieves finer control over the generative process than a single-pass approach. This reduces the need for manual post-editing and thereby provides a measurable improvement in system throughput and latency.
   The server performs correction processing on the model's output to generate corrected text information. In one embodiment, the server decomposes correction processing into at least two modules: a translation module and an emotion intensity adjustment module. The translation module checks whether the target language requirement has been met and if necessary calls the generative AI model with a translation-specific prompt sentence. The emotion intensity adjustment module assesses the severity of emotion in the generated text using rule-based pattern detection or a lightweight classifier model, and if the detected intensity does not match the desired level, the module constructs a new prompt sentence to request a milder or stronger expression. These modules operate on structured representations of text and metadata, such as objects containing text content, language tags, and numeric emotion intensity scores. This modular structuring produces technical benefits because individual modules can be optimized independently and reused across different workflows.
   The server stores the corrected text information in a storage medium, such as a relational database or key-value store. The server uses a structured schema that includes fields for an input text, a corrected text, an associated prompt sentence identifier, timestamps, user identifiers, and processing parameters. The server writes these records using a database management system and maintains indexes on key fields such as user identifier and creation time. As a result, the server can retrieve past corrected texts efficiently according to retrieval conditions. This structured history management improves data locality and caching performance, reduces repeated computation for similar inputs, and enables the server to re-use or adapt previously generated texts in subsequent sessions, which in turn reduces calls to the external generative AI model and decreases communication load on the network.
   The server provides the corrected text information to the user via the terminal. The server formats the corrected text according to client requirements and transmits it over the network. The terminal receives the corrected text and displays it on its display. The user can read the translated and emotion-adjusted text, copy it, or send it to another application. In some embodiments, the terminal issues a retrieval request to display a history of previously generated texts, and the server responds by searching the storage medium using the retrieval condition and returning a list of relevant records.
   The server improves computer technology in several ways. By performing structured preprocessing and prompt generation before contacting the generative AI model, the server reduces the size and complexity of the prompt sentences required to achieve a desired result, which leads to faster inference and lower bandwidth consumption. By enforcing a schema for storing corrected text information and its associated prompt sentences, the server reduces duplication of work and enables rapid look-up of prior results, improving storage efficiency and retrieval latency. By coordinating multiple rounds of model interaction using deterministic rules and emotion intensity evaluation, the server reduces the variance of outputs, which in turn reduces error rates in downstream applications such as communication support, automated messaging, or content moderation.
   The server does not simply automate a human translation task; instead, the server implements a non-conventional pipeline that exploits specific characteristics of a neural network-based generative AI model. A human translator would not manually specify token-level generation parameters, nor would a human manage a structured database of prompt sentences and outputs to control subsequent generations. The server, however, implements these machine-oriented operations to shape the internal probability distributions and attention patterns within the model, producing more consistent and efficient computational behavior. In particular, the server's preprocessing eliminates irregularities that often cause neural networks to allocate computation to noise tokens, and the server's prompt engineering reduces the search space of possible continuations by imposing task-specific constraints, thus improving both accuracy and speed.
   The server may employ alternative generative AI models and architectures. In one embodiment, the server uses a sequence-to-sequence encoder-decoder architecture with attention, where an encoder transforms the preprocessed text into a sequence of hidden states and a decoder generates the corrected text conditioned on both the hidden states and a prompt sentence context. In another embodiment, the server uses a transformer decoder-only model trained with masked language modeling and next-token prediction objectives. The server may also use a smaller classifier neural network to estimate emotion intensity scores from candidate texts for use in the correction module. These variations all operate within the same general framework of server-controlled prompt generation, model invocation, and structured history storage.
   The server can vary learning methods and hyperparameters of the generative AI model. During training, the external apparatus may use mini-batch stochastic gradient descent, adaptive learning rate schedules, gradient clipping, and regularization techniques such as dropout. The apparatus can define a composite loss function that includes a language modeling loss term and an auxiliary term capturing deviation from desired emotion intensity. By minimizing this composite loss, the generative AI model learns to satisfy translation and emotion constraints more faithfully, so that at inference time the server can obtain high-quality outputs with fewer calls and lower correction overhead.
   The server supports multiple implementations of the storage medium and data management strategy. In one embodiment, the server uses a relational database system to store records in normalized tables with foreign keys linking prompt sentences and user accounts. In another embodiment, the server uses a document-oriented store to hold JSON-like representations of input and corrected text items. In either case, the server maintains indexes on commonly used retrieval conditions such as user identifier or emotion type. By aligning database schema with the needs of the generative processing pipeline, the server improves read and write performance for usage patterns specific to this type of application.
   The terminal may be realized as a smartphone, a tablet, a laptop, or another networked device. The terminal executes a client application that provides an interface for entering text, selecting source and target languages, and specifying emotion preferences. The terminal may perform lightweight validation and formatting of user input but does not implement the core preprocessing, prompt generation, or model-calling logic; instead, these functions remain in the server. This separation allows central optimization and coordinated updates to the processing pipeline, reducing inconsistencies across different client platforms and simplifying deployment and maintenance.
   The user interacts with the system in natural language without needing to understand the underlying technical architecture. The user only sees that the system returns translations and emotionally tuned expressions more quickly, with fewer errors, and with consistent tone across different sessions. Internally, the server achieves this behavior by controlling data flow between preprocessing modules, generative AI modules, correction modules, and storage modules, as described above.
   The described embodiments are not limiting. The server may use different hardware configurations, different neural network architectures, or different prompting strategies while still falling within the scope of the claims, as long as the server processor is configured to generate structured prompt sentences including translation and emotion-intensity instructions, to interact with a generative AI model, to perform correction processing including translation and emotion adjustment, and to store and provide corrected text information as structured data.

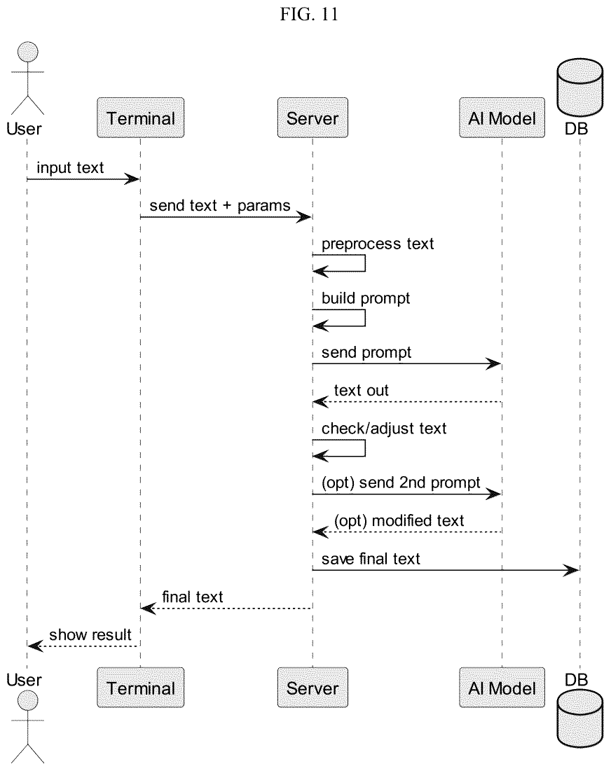

The following describes the processing flow using FIG. 11.

### Step 1:

The user operates the terminal to input an original text.
The user uses a keyboard or touch interface of the terminal to enter character information that expresses an emotional state, for example, “I am angry.”
The terminal displays the entered text in an input field and allows the user to confirm or edit the text.
The terminal sets metadata such as a source language (e.g., “en”), a target language (e.g., “ja”), and a desired emotion intensity (e.g., “mild”) as parameters associated with the input text.
Input: raw text from the user (e.g., “I am angry”) and associated settings.
Output: a structured input object at the terminal containing the text string and metadata (source language, target language, emotion preference).

### Step 2:

The terminal transmits the structured input object to the server.
The terminal serializes the input object into a request message, for example, a JSON body of an HTTP POST request, and attaches headers such as content type and authentication information.
The terminal sends the request to a predetermined API endpoint of the server via a network connection.
The terminal starts a waiting state for the server response and may display a progress indicator on the display.
Input: structured input object held in the terminal.
Output: network request data sent to the server and a pending state maintained until a response is received.

### Step 3:

The server receives and validates the request from the terminal.
The server accepts the network packet through a network interface and passes the HTTP request to an application module.
The server parses the request body, extracts the input text, language codes, and emotion preference flags, and verifies that the required fields are present and correctly formatted.
The server rejects malformed or unauthorized requests and, for valid requests, stores request metadata such as timestamps and user identifiers in temporary memory or logs.
Input: network request data containing structured input information.
Output: a validated internal data structure on the server representing the input text and associated parameters, or an error response if validation fails.

### Step 4:

The server performs preprocessing on the input text.
The server converts the character encoding to a standard encoding such as UTF-8 and normalizes characters (for example, converting full-width characters to half-width where appropriate and unifying line endings).
The server removes unnecessary characters, such as control codes, redundant spaces, invisible characters, or markup, using deterministic string operations and pattern matching.
The server determines or confirms the language of the text by analyzing character n-gram statistics or invoking a language detection library and compares the detected language with the provided source language code.
Input: validated internal data structure containing raw input text and metadata.
Output: preprocessed character information, including a cleaned text string and confirmed language codes, stored in an updated internal data structure.

### Step 5:

The server generates a prompt sentence for a generative AI model.
The server selects a prompt template based on the source language, target language, and emotion preference parameters.
The server fills placeholder fields in the template with the preprocessed text and explicit instructions for translation and emotion intensity adjustment.
For example, the server generates the following prompt sentence:
“Act as a bilingual emotional expression assistant. Translate the following sentence from English into natural Japanese. Then soften the emotional intensity so that the anger feels mild. Output only the final Japanese sentence, without any explanation. Sentence: ‘I am angry’.”
   The server stores the generated prompt sentence in memory alongside an identifier for tracking.
   Input: preprocessed character information and configuration parameters (languages, desired emotion intensity, style options).
   Output: a complete prompt sentence string to be supplied to the generative AI model and an updated internal record linking the prompt sentence to the input.

### Step 6:

The server transmits the prompt sentence to an external apparatus that executes the generative AI model.
The server constructs a model request object containing the prompt sentence, a model identifier, and generation parameters such as maximum tokens, temperature, and sampling mode.
The server sends this request object over a secure communication channel to the generative AI model endpoint and enters a waiting state for the response.
The server may apply timeouts and retry policies to handle network or service errors.
Input: prompt sentence string and model configuration parameters.
Output: a model request message sent to the external apparatus and a pending state awaiting a text output.

### Step 7:

The server receives and parses a text output generated by the generative AI model.
The external apparatus executes neural network inference using the prompt sentence as input and returns a response containing a generated text string.
The server receives the response message, extracts the generated text field, and checks that the field is not empty.
The server optionally logs the length and a truncated sample of the output for monitoring purposes.
Input: response message from the external generative AI model.
Output: an internal representation of the text output (e.g., “I am a little angry.”) associated with the prompt sentence and the original input.

### Step 8:

The server performs correction processing on the text output.
The server verifies that the generated text is in the target language by running a language determination routine and checking the result against the desired target language code.
The server checks whether the emotional expression and intensity match the requested configuration, for example by applying pattern-based rules or a lightweight classifier that assigns an emotion intensity score.
If the language or emotion intensity does not fully match the requirements, the server constructs a second prompt sentence that instructs the model to correct specific aspects. For example:
“Adjust the emotional intensity of the following Japanese sentence so that the feeling is mild and polite. Return only the corrected Japanese sentence. Sentence: I am angry.”
   The server sends this second prompt sentence to the generative AI model and obtains a modified text.
   The server adopts the resulting modified text as corrected text information that satisfies both language and emotion constraints.
   Input: first-round text output and target conditions (language, emotion intensity, style).
   Output: corrected text information (for example, a final sentence such as “I am a little angry.”) that has been validated and, if needed, further refined by an additional model interaction.

### Step 9:

The server stores the corrected text information in a storage medium as structured data.
The server creates a database record that includes fields for the original input text, the corrected text, identifiers of the prompt sentences used, timestamps, and user-related information.
The server issues a write operation to a database management system, which persists the record in non-volatile storage and updates associated indexes.
The server caches recently stored records in memory to accelerate potential near-term retrieval.
Input: corrected text information and associated metadata (input text, prompt sentence information, timestamps, user ID).
Output: a stored history record in the database, and a record identifier or confirmation status indicating successful storage.

### Step 10:

The server prepares and transmits a response containing the corrected text information to the terminal.
The server constructs a response object that includes at least the corrected text and may optionally include the original text or a reference identifier for history retrieval.
The server serializes this object and sends it to the terminal as a response message over the network.
The server may also update internal metrics, such as processing time and model usage counts, for system optimization.
Input: corrected text information and, optionally, database record identifiers.
Output: a response message delivered to the terminal containing the corrected text to be presented to the user.

### Step 11:

The terminal receives and displays the corrected text to the user.
The terminal parses the response message, extracts the corrected text field, and renders the text on the display using UI components.
The terminal may additionally show the original input for comparison and provide user interface controls to copy or share the corrected text.
The terminal stores a local summary of the result, such as the original and corrected texts, to present in a recent history list.
Input: response message from the server containing the corrected text.
Output: visual presentation of the corrected text on the terminal display and, optionally, a local history entry accessible to the user.

### Step 12:

The user optionally requests retrieval of past corrected texts via the terminal.
The user operates a history or archive screen on the terminal to request previously generated outputs based on criteria such as date range or keyword.
The terminal packages the retrieval condition into a request and sends it to the server.
The server searches the stored structured data according to the retrieval condition and returns matching corrected texts, which the terminal then displays to the user as a list or detailed view.
Input: retrieval condition from the user as interpreted by the terminal.
Output: a set of corrected text records provided by the server and presented on the terminal for the user's further use.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern communication environments, users increasingly exchange user-generated content across different languages and cultural contexts using networked computing devices. Conventional systems that rely on fixed translation engines and rule-based text filters perform translation and sentiment handling as separate, sequential processes. Such architectures suffer from multiple technical drawbacks.
First, the processing pipeline typically requires the application server to invoke a translation engine, store or buffer the result, then invoke a separate correction engine and a separate sentiment adjustment engine. This multi-stage orchestration increases end-to-end latency and computational overhead on the server, and makes it difficult to provide real-time interaction in chat and messaging applications. When users expect near-instantaneous responses, this latency degrades the responsiveness of the system and results in a poor interactive experience.
Second, existing systems generally do not exploit the capability of modern generative AI models to handle translation, correction, and sentiment adjustment in a single inference operation. Because the server does not structurally integrate prompt design and response handling into its processing pipeline, the server generates suboptimal prompts or uses generic prompts that fail to control the model's behavior precisely. This can lead to inconsistent translation quality, unpredictable sentiment adjustment, and additional application-level post-processing that further increases processing time and resource usage.
Third, many systems lack a structured mechanism for combining user-specific or context-specific sentiment requirements with real-time translation. For example, a system may apply a static sentiment filter after translation, without taking into account a target sentiment degree that is appropriate for specific recipients, channels, or application policies. As a result, the server cannot reliably enforce consistent sentiment control across recipients, and cannot dynamically adjust the emotional intensity of content in accordance with system-defined targets, which complicates moderation and personalization.
Fourth, conventional database usage in such systems is often limited to storing final messages. There is no integrated control flow that ties together: (i) input acquisition, (ii) generation of a prompt sentence encoding translation and sentiment policies, (iii) invocation of a generative AI model, (iv) structured extraction of translated and sentiment-adjusted text, and (v) distribution to multiple recipients in real time. This fragmented design leads to redundant data operations, inefficient use of network resources, and difficulty in scaling the system for large numbers of concurrent users.
   Accordingly, there is a need for an improved computer-implemented system and server-side processing architecture that: (1) treats prompt sentence generation as a first-class computational step; (2) drives a generative AI model to perform translation, expression correction, and sentiment-degree adjustment in a single integrated inference; (3) maintains structured storage of both translated text and sentiment-adjusted text; and (4) controls communication and distribution so that appropriately adjusted content can be presented to users and other recipients in real time, thereby improving the efficiency, scalability, and responsiveness of the underlying computer system.

The specific processing by the specific processing unit 290 of the data processing device 12 in Application Example 1 is realized by the following means.

The present invention provides a server comprising a processor configured to receive natural-language input information from a user, preprocess the input information to normalize the input information as text data, generate a prompt sentence based on the text data, the prompt sentence including an instruction for causing a generative AI model that uses a neural network to execute, in combination, translation processing, expression-correction processing, and sentiment-degree adjustment processing, transmit the prompt sentence to the generative AI model via a network and obtain response data including a translated text and a sentiment-adjusted text from the generative AI model, store the translated text and the sentiment-adjusted text in a data management apparatus in association with user or recipient information, generate distribution data based on the stored translated text and sentiment-adjusted text for distribution to terminals of other users, and control communication such that at least one of the user and the other users is able to be presented with the translated text and the sentiment-adjusted text in substantially real time. This enables the underlying computer system to offload multiple language and sentiment operations into a single model inference driven by a structured prompt sentence, reduce server-side orchestration overhead and latency, enforce target sentiment degrees consistently across recipients by encoding sentiment control in the prompt and in the server's data flow, and efficiently store and distribute both translated and sentiment-adjusted content so that networked terminals can display moderated multilingual messages with improved responsiveness and scalability.

The term “user” refers to a human or software entity that provides natural-language input information to the system and may view translated and sentiment-adjusted text presented by a terminal.

The term “processor” refers to one or more hardware processing units, such as a central processing unit or a processing core, configured to execute instructions that implement the functions of the server described in the present specification.
The term “server” refers to a computing apparatus including the processor and associated memory, storage, and communication interfaces, configured to perform input acquisition, prompt sentence generation, interaction with a generative AI model, data storage, and distribution control as described herein.
The term “natural-language input information” refers to character data representing words, phrases, or sentences expressed in a human language, such as a message or query input by the user.
The term “preprocess” refers to performing one or more operations on the input information, such as normalization, cleaning, tokenization, or format conversion, to generate text data in a form suitable for subsequent processing by the server and the generative AI model.
The term “text data” refers to a data structure representing natural-language content in a machine-processable format, such as a character string or an array of characters, that is obtained after preprocessing the input information.
The term “prompt sentence” refers to a text sequence constructed by the processor that encodes instructions and context for the generative AI model, and that is used as an input to cause the generative AI model to perform at least translation processing, expression-correction processing, and sentiment-degree adjustment processing.
The term “generative AI model” refers to a machine-implemented model, implemented for example by a neural network, that generates text in response to a prompt sentence by performing learned transformations on input tokens.
The term “neural network” refers to a computational model comprising multiple layers of interconnected nodes and trainable parameters, configured to process input data and generate output data by applying mathematical operations such as weighted summation and non-linear activation.
The term “translation processing” refers to a process of converting text expressed in a first natural language into text expressed in a second natural language while preserving at least a main part of the original meaning.
The term “translated text” refers to text generated by the generative AI model as a result of translation processing applied to the input information or the text data.
The term “expression-correction processing” refers to a process of modifying text to correct linguistic errors, such as grammatical, spelling, or usage errors, and to improve clarity, while maintaining the intended meaning of the text.
The term “sentiment-degree adjustment processing” refers to a process of modifying text so that a strength or type of emotional expression in the text is changed to match a desired sentiment degree, such as softening or neutralizing overly strong emotional content.
The term “sentiment-adjusted text” refers to text generated by the generative AI model, or by the processor based on the model output, in which an emotional expression has been adjusted to correspond to a target sentiment degree.
The term “sentiment degree” refers to a parameter or indicator representing at least one of the intensity and polarity of an emotional expression contained in text, such as strong positive, weak positive, neutral, weak negative, or strong negative.
The term “target sentiment degree” refers to a sentiment degree that is specified or determined by the server for presentation to a recipient, and that is used as a reference for the sentiment-degree adjustment processing.
The term “response data” refers to data received from the generative AI model in response to the prompt sentence, the data including at least one of the translated text and the sentiment-adjusted text and optionally additional metadata.
The term “data management apparatus” refers to a storage subsystem, such as a database system or a non-volatile storage device, that stores and manages the translated text, the sentiment-adjusted text, and associated metadata under control of the processor.
The term “distribution data” refers to data generated by the processor based on the translated text and the sentiment-adjusted text stored in the data management apparatus, the data being formatted for transmission to terminals of recipients.
The term “terminal” refers to an end-user device, such as a client computer, a mobile device, or another communication apparatus, configured to send input information to the server and/or receive and present translated text and sentiment-adjusted text to a user.
The term “recipient” refers to a user or entity that receives distribution data from the server via a terminal and is presented with the translated text and/or the sentiment-adjusted text.

The term “communication control” refers to control performed by the processor over transmission and reception of data between the server, the generative AI model, and terminals, including scheduling, routing, and protocol handling, in order to achieve real-time or near-real-time presentation of content.

The term “real time” refers to a responsiveness characteristic in which a delay between receiving input information at the server and presenting corresponding translated text and/or sentiment-adjusted text to at least one user is sufficiently small that the interaction is perceived as substantially immediate in a conversational or interactive application.

In one embodiment, a server, a plurality of terminals, and a network collectively implement the system. The server includes at least one processor, a main memory, a non-volatile storage device, and a network interface. The server executes an operating system such as a general-purpose server operating system, and executes an application program that implements the functions described in the claims. The terminals include client devices such as smartphones, tablet computers, or personal computers, each having a processor, a memory, a display, an input interface such as a touch panel or keyboard, and a communication module for communicating with the server over a wired or wireless network.

The server stores, in the non-volatile storage device, a program composed of multiple software modules. The server loads this program into the main memory and executes it by the processor. The program includes at least: a communication module, a preprocessing module, a prompt generation module, a generative AI interaction module, a response parsing module, a data management module, and a distribution control module. The server also stores configuration data defining, for example, language pairs, sentiment-degree scales, model parameters, and prompt templates.
The terminal executes a client application such as a mobile application or web browser application. The terminal presents an input field to the user on the display. The user uses the terminal to enter natural-language text, for example, “I am very happy” or “I am extremely angry about this situation.” The terminal encodes the text as character data and attaches metadata such as a user identifier, a conversation identifier, and a timestamp. The terminal transmits this data to the server via the network interface using a communication protocol such as HTTPS.
The server receives the text and metadata via the communication module and stores them in the main memory in a structured data record. The data record may include fields such as original_text, source_language, user_id, conversation_id, and creation_time. The preprocessing module of the server normalizes the original_text by, for example, trimming leading and trailing spaces, converting full-width and half-width characters to a consistent form, normalizing Unicode representations, and optionally detecting an input language using a language identification algorithm. In one variation, the server uses a statistical or neural language identification model that takes character n-grams or token sequences as features and outputs a language code.
The server then uses the prompt generation module to construct a prompt sentence. The server loads a prompt template from the non-volatile storage device into memory. The template may be, for example:
“Translate and adjust the sentiment of the following text: ‘{TEXT}’”
   or a more detailed form such as:
“Translate the following text from English to Japanese, correct any grammatical errors, and soften the emotional intensity while preserving the core meaning: ‘{TEXT}’”
   or:
“Translate the following text from English to Japanese and output two lines:
Translated: [natural translation]
Adjusted: [translation whose sentiment intensity is reduced to a neutral or mild level].
Text: ‘{TEXT}’”
   The server replaces the placeholder {TEXT} with the normalized original_text, while escaping quotation marks and line breaks to avoid ambiguity when sent to the generative AI model. In another embodiment, the server incorporates a target sentiment degree into the prompt, for example:
“Translate the following English text into Japanese and adjust the sentiment so that the sentiment degree becomes ‘mild positive’. Output:
Translated: . . .
Adjusted: . . .
Text: ‘{TEXT}’”
   or:
“Translate the following English text into Japanese and adjust the sentiment so that it is suitable for polite communication with business partners. Text: ‘{TEXT}’”
   The server selects an appropriate template based on configuration or user settings, and constructs the final prompt sentence as a single continuous text sequence. The server stores this prompt sentence in a data structure associated with the original_text.
   The server uses the generative AI interaction module to transmit the prompt sentence to an external or internal generative AI model. In one embodiment, the server communicates with a remote generative AI service via HTTPS, sending the prompt sentence and model parameters as part of a request. The model parameters may include, for example, model_name, temperature, maximum_output_length, and top_k or top_p sampling parameters. In another embodiment, the server hosts the generative AI model locally on one or more graphics processing units (GPUs) or specialized accelerators.
   The generative AI model is implemented as a neural network having a transformer-type architecture. The model includes an embedding layer that converts tokens into vectors, a plurality of self-attention layers that compute attention scores between tokens, feed-forward layers that apply linear transformations and non-linear activation functions, and an output layer that converts hidden representations into probability distributions over a vocabulary. The model has been trained, before deployment, using a large corpus of text in multiple languages. The training process includes: converting training text into token sequences; computing a loss function, such as cross-entropy loss, between predicted token distributions and ground-truth tokens; and updating model parameters using a gradient-based optimization algorithm, such as stochastic gradient descent or Adam. The training may be performed with teacher-forcing, where the correct previous tokens are used as inputs when predicting the next token, and may include regularization techniques such as dropout or layer normalization.
   The server does not perform training during normal operation; instead, the server uses the trained model in an inference mode. The generative AI model receives the prompt sentence as an input token sequence. The model computes internal attention weights and hidden states that represent semantic relationships among tokens, including explicit instructions such as “Translate,” “correct,” and “adjust the sentiment,” as well as the content of the original_text. Because the prompt sentence is structured to encode multiple operations-translation, correction, and sentiment-degree adjustment-the model performs a single combined inference pass that produces an output sequence representing both a translated text and a sentiment-adjusted text.
   The server receives the output sequence from the generative AI model as response data. The response data typically includes a text string generated by the model, and may include additional metadata such as token usage counts. The response parsing module of the server interprets this text string according to the output format specified in the prompt. For example, if the model is requested to output:
“Translated: I am very happy.
Adjusted: I am happy.”
   the server splits the output on line breaks, searches for prefixes such as “Translated:” and “Adjusted:”, and extracts the corresponding portions as a translated_text field and a sentiment_adjusted_text field. If the model is requested to output a single sentence that is both translated and sentiment-adjusted, the server stores that sentence as sentiment_adjusted_text and may regard it as the primary output.
   The data management module of the server writes the original_text, translated_text, and sentiment_adjusted_text, along with metadata such as user_id, conversation_id, source_language, target_language, sentiment_degree, and target_sentiment_degree, into a data management apparatus such as a relational database or a key-value store. In one embodiment, the server uses a table with columns corresponding to these fields and uses an index on conversation_id and creation_time to enable efficient retrieval of messages for a particular conversation.
   The distribution control module of the server determines which terminals should receive each sentiment_adjusted_text. The server may refer to a conversation membership table or a subscription list. The server constructs distribution data including one or both of translated_text and sentiment_adjusted_text, a message identifier, a sender identifier, and a timestamp. The server controls communication with the terminals using a push mechanism such as WebSockets or server-sent events. The server transmits the distribution data to each terminal that is currently connected and subscribed to the relevant conversation.
   The terminal receives the distribution data through its communication module and stores the data in a local buffer or cache. The terminal then displays the sentiment_adjusted_text in a user interface component such as a chat bubble or list item. The user of a receiving terminal can read, almost in real time, a message that has been translated and sentiment-adjusted by the server using the generative AI model. If the terminal is temporarily offline, the server may queue the distribution data and retransmit it when the terminal reconnects, thereby maintaining consistency of conversational history.
   In this architecture, the server does not simply replace human translation and editing. The server coordinates a specialized flow that leverages the generative AI model's ability to process complex instructions encoded in the prompt sentence. The server integrates prompt generation, model invocation, and structured parsing into a single computational pipeline. This integration reduces the number of separate components that must be invoked for translation, correction, and sentiment control, thereby reducing latency, simplifying error handling, and lowering network usage between subsystems.
   The server improves computer functionality by reducing redundant data transfers and processing steps. For example, in a conventional design, the server might call a first service to translate text, a second service to correct grammar, and a third service to adjust sentiment. Each call would involve separate serialization, network transmission, and deserialization, increasing CPU usage and memory pressure. In contrast, in the described system, the server constructs a single prompt sentence that simultaneously encodes all required tasks, performs a single network call to the generative AI model, and receives a unified response. This reduces the number of network round trips, decreases queuing delays, and improves throughput for large numbers of concurrent users.
   The server also improves accuracy and consistency of sentiment handling. By structuring the prompt sentence to explicitly include a target sentiment degree or target emotional tone, the server ensures that the generative AI model uses this information as part of its internal computation. Because the generative AI model has been trained on diverse expressions of emotion and can represent fine-grained sentiment distinctions in its internal vector space, it can perform sentiment-degree adjustment at a more granular level than a simple rule-based filter. The server thus achieves a lower error rate in sentiment adjustment and reduces the need for manual human intervention.
   The server explicitly controls how sentiment is calculated and adjusted. In one embodiment, the server maintains a discrete scale of sentiment degrees, such as: strong negative, moderate negative, neutral, moderate positive, strong positive. The server assigns each incoming message an estimated sentiment degree using a separate sentiment-analysis model or heuristic, and then determines a target sentiment degree based on conversation policy or user preference. The server then embeds these degrees in the prompt sentence, for example:
“Translate the following text into Japanese and adjust the sentiment so that the sentiment degree becomes ‘neutral’ on a five-level scale from strong negative to strong positive. Text: ‘{TEXT}’”
   This explicit encoding ensures that the generative AI model uses a non-conventional, system-specific sentiment scale, rather than a generic notion of positive or negative sentiment. The server thus applies a specific rule-based framework for sentiment control that is unique to the system, and not a mere automation of human translation.
   The generative AI model, when processing such a prompt sentence, internally maps tokens such as “neutral” and “five-level scale” to specific regions of its learned vector space, and the attention mechanism guides the generation process accordingly. Because this mapping arises from prior training with examples where similar instructions were present, the model can produce output whose sentiment fits the requested level. The server's prompt generation and parsing logic ensure that this model capability is systematically used to modify the internal text flow of the system, rather than merely generating arbitrary text.
   The server's data structures are tailored to support this integrated pipeline. For example, the message table may include fields for both raw_model_output and parsed_fields, such as translated_text and sentiment_adjusted_text. The server may store raw_model_output for audit or retraining purposes, while the parsed_fields are used for distribution. This separation reduces the need for re-invoking the generative AI model if new formatting or parsing rules are introduced, thereby improving computation efficiency.
   The system operates in real time from the perspective of the user. Because the server performs a single inference per message and avoids multi-stage pipelines, the round-trip time between a user sending text on a terminal and another user receiving a sentiment-adjusted translation can be reduced to a fraction of a second, depending on network conditions. This improved latency represents a technical enhancement in the operation of the communication infrastructure and is not simply a business or usability improvement.
   In another embodiment, the server hosts the generative AI model locally. The server allocates GPU memory for model parameters, preloads the model weights into device memory, and performs batched inference on incoming prompt sentences. By batching multiple prompt sentences into a single matrix operation, the server reduces overhead per message and achieves higher throughput. The server's batching algorithm groups messages based on maximum token length and conversation priority, ensuring that short messages are not delayed unnecessarily. This batching strategy, combined with the integrated prompt design, leads to improved utilization of computing resources.
   In an alternative embodiment, the server uses different prompt templates depending on the target language pair and desired sentiment behavior. The server may, for example, use:
“Translate the following Japanese text into English and keep the sentiment as close as possible to the original, but correct any grammatical mistakes: ‘{TEXT}’”
   for one context, and:
“Translate the following text into Spanish and make the emotional tone calm and respectful: ‘{TEXT}’”
   for another context. The server records, in the data management apparatus, which template was used for each message. This allows the system to analyze which templates yield better performance, and to adaptively select templates that minimize error rates, thereby further improving accuracy.

In a further embodiment, the server applies additional post-processing rules that are specifically designed for technical consistency. For example, the server may scan the translated_text for domain-specific terminology and replace certain terms with standardized equivalents stored in a terminology database. The server can instruct the generative AI model via the prompt sentence to follow such terminology rules, for example:
“Translate the following technical support message into Japanese, ensuring that the following terms are used exactly as given: ‘server’->‘server’ (in Japanese), ‘client’->‘client’ (in Japanese). Then adjust the sentiment so that it is polite and non-confrontational. Text: ‘{TEXT}’”
   Because the generative AI model receives explicit mapping rules within the prompt, and because the server enforces consistency by post-processing, the system provides improved accuracy for specialized applications, such as technical support systems. This is a technical effect on the quality and consistency of machine-generated text in a constrained domain.
   In each of these embodiments, the server, the terminals, and the generative AI model cooperate to implement a set of processing operations that improve the functioning of the underlying computer system. The integration of prompt sentence construction, multi-function inference, structured parsing, and real-time distribution achieves reductions in latency, improvements in sentiment-control accuracy, more efficient use of network and computational resources, and more reliable management of multilingual data. These technical advantages arise specifically from the described configuration and interaction of the server, terminals, and generative AI model, rather than from mere automation of a human translation or editing procedure.

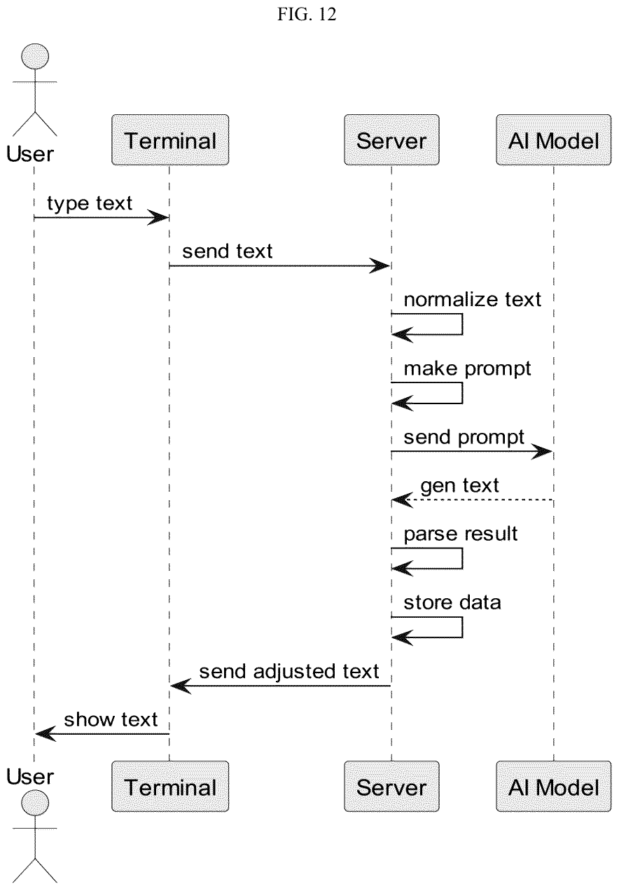

The following describes the processing flow using FIG. 12.

### Step 1:

User uses the terminal to input natural-language text.
Terminal displays an input field on a graphical user interface and accepts a character string such as “I am very happy” or “I am extremely angry about this situation.”
Input: keystroke or touch events from the user.
Terminal converts these events into a Unicode character sequence, validates that the length is within a preset limit, and stores the sequence in a local buffer as input_text.
Output: input_text and associated metadata (for example, user_id, conversation_id, local_timestamp) stored in the terminal's memory.

### Step 2:

Terminal transmits the input_text and metadata to the server.
Terminal packages input_text and metadata into a structured message and sends it via a network stack using a protocol such as HTTPS to a predefined server endpoint.
Input: input_text and metadata from Step 1.
Terminal serializes the data into a request body, performs encryption at the transport layer, and writes the encrypted bytes to a network socket.
Output: an HTTP request containing the input_text and metadata, delivered to the server.

### Step 3:

Server receives the request and normalizes the input text.
Server, through a communication module, accepts the HTTP request, decodes the request body, and extracts fields including original_text, user_id, and conversation_id.
Input: HTTP request bytes containing serialized input_text and metadata from Step 2.
Server parses the bytes into an internal data structure, trims whitespace, normalizes Unicode representations, optionally converts character width, and stores the result as normalized_text.
Output: normalized_text and associated metadata stored in server memory as a normalized message record.

### Step 4:

Server determines language information and sentiment information for the normalized_text.
Server applies a language identification routine and, in some embodiments, a sentiment estimation routine to the normalized_text.
Input: normalized_text from Step 3.
Server analyzes character patterns or token sequences, computes scores for possible languages, selects a source_language code, and optionally computes a sentiment_degree indicator on a predefined scale (for example, strong negative to strong positive).
Output: source_language, and optionally estimated sentiment_degree, attached to the normalized message record.

### Step 5:

Server generates a prompt sentence for a generative AI model.
Server uses the prompt generation module to construct a text instruction that includes translation, correction, and sentiment-degree adjustment directives.
Input: normalized_text, source_language, target_language (from configuration or user settings), and optionally sentiment_degree and target_sentiment_degree from Step 4.
Server loads a prompt template, replaces a placeholder such as {TEXT} with the normalized_text, and, when applicable, inserts explicit strings such as a target sentiment description (for example, “mild positive” or “neutral”) into the template.
Output: a prompt_sentence that explicitly instructs the generative AI model, stored as a character string in server memory.

### Step 6:

Server transmits the prompt_sentence to the generative AI model.
Server uses a generative AI interaction module to form a model request and send it to the model service or local model engine.
Input: prompt_sentence and model parameters (for example, model_name, temperature, max_tokens) from Step 5.
Server serializes the prompt_sentence and parameters into a request object, sends the request via a network interface or local API call, and records a request identifier for correlation.
Output: a model invocation event and a pending state awaiting a response from the generative AI model.

### Step 7:

Generative AI model processes the prompt_sentence and generates an output text.
Generative AI model tokenizes the prompt_sentence, applies an embedding layer, passes token embeddings through multiple self-attention and feed-forward layers, and decodes predicted tokens into an output sequence.
Input: tokenized representation of the prompt_sentence from Step 6.
The generative AI model computes attention weights and probability distributions over a vocabulary at each decoding step, selects tokens according to configured sampling parameters, and concatenates selected tokens into a generated_text string that embeds both translation and sentiment-adjusted content.
Output: generated_text representing model_response, provided to the server.

### Step 8:

Server receives and parses the model_response.
Server obtains the generated_text from the generative AI model's response and interprets it according to the format specified in the prompt.
Input: model_response including generated_text from Step 7.
Server extracts the generated_text, splits the string by line breaks or markers such as “Translated:” and “Adjusted:”, and assigns segments to translated_text and sentiment_adjusted_text fields.
Output: translated_text and sentiment_adjusted_text as separate fields associated with the original message record.

### Step 9:

Server stores the translated_text and sentiment_adjusted_text in a data management apparatus.
Server uses the data management module to perform a persistent write operation.
Input: translated_text, sentiment_adjusted_text, and message metadata (user_id, conversation_id, timestamps, language codes) from Step 8.
Server constructs a database record, maps each field to corresponding columns in a table or keys in a document, and executes an insert or update operation using a database driver, thereby writing the data to non-volatile storage.
Output: a stored message entry with a unique message_id that can be retrieved for subsequent distribution.

### Step 10:

Server prepares distribution data for recipient terminals.
Server identifies recipient users and formats outgoing message content for each recipient context.
Input: stored message entry including translated_text, sentiment_adjusted_text, and conversation_id from Step 9.
Server queries a membership list to obtain recipient_user_ids, constructs a payload including at least sentiment_adjusted_text, message_id, sender_user_id, and timestamps, and optionally includes translated_text or additional metadata depending on system policy.
Output: distribution_data objects tailored for each recipient user, queued for transmission.

### Step 11:

Server transmits the distribution_data to each terminal.
Server uses a push mechanism such as WebSocket or server-sent events to deliver the processed content in real time.
Input: distribution_data from Step 10.
Server serializes each distribution_data object into a message frame, writes the frames to corresponding network connections, and marks messages as delivered or pending based on acknowledgment from terminals.
Output: network messages carrying translated and sentiment-adjusted content delivered toward terminals.

### Step 12:

Terminal receives and displays the sentiment_adjusted_text to the user.
Terminal's communication module reads incoming message frames, decodes the payload, and updates the user interface.
Input: network messages containing distribution_data from Step 11.
Terminal parses the payload, extracts sentiment_adjusted_text, inserts it into a local message list, and renders it on the display in a chat window or similar UI component.
Output: a visible representation of the sentiment_adjusted_text on the terminal display, enabling the user to view the translated and sentiment-adjusted message in near real time.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems and text generation systems using generative AI models are typically configured to generate responses solely based on the literal content of user input, without robustly incorporating the user's emotional state as a first-class control signal in the generation pipeline. As a result, such systems frequently output responses that are formally correct but are inappropriate in tone or style, leading to user frustration, reduced trust, and ineffective human-computer interaction.

Existing systems that attempt to consider user sentiment often treat emotion analysis as an auxiliary function and do not tightly integrate emotion information into the construction of the prompt sentence used for the generative AI model. In many cases, the mapping from detected emotion to concrete generative instructions is ad hoc, non-transparent, or hard-coded, and the system does not systematically record the relationship between user input, emotional state, prompt sentence, and generated text. Consequently, it is difficult to adapt and optimize the generative behavior over time in a data-driven manner, and it is also difficult to guarantee consistency and safety of generated responses.
Further, in known architectures, the generative AI model is often used as a monolithic black box. Input text is simply forwarded to the model, and the system has limited ability to control intermediate representations such as prompt structure, style constraints, and safety constraints. This leads to technical problems such as increased rate of harmful or inappropriate expressions, lack of control over response length and format, and inability to guarantee that communication goals (for example, de-escalation of anger or reassurance of anxiety) are actually reflected in the output. These issues degrade the technical performance of the overall dialog system, including effectiveness, robustness, reproducibility, and maintainability of the response generation process.
Accordingly, there is a need for an improved computer-implemented system and server architecture that: (i) systematically analyzes a user's emotional state from natural language input, (ii) generates a structured, emotion-conditioned prompt sentence that explicitly encodes tone, politeness, explanation level, and communication purpose, (iii) drives a generative AI model under this prompt-level control, and (iv) records the associations among user input, emotional state, prompt sentence, and generated text for subsequent optimization and control. By solving these technical problems, the system can improve the quality, controllability, and safety of AI-generated text, thereby improving the functioning of the computer system itself as a human-machine communication platform.

The specific processing by the specific processing unit 290 of the data processing device 12 in Example 2 is realized by the following means.

The present invention provides a server comprising a processor configured to receive natural language input information from a user via a terminal, preprocess the input information while converting the input information into structured data, input the preprocessed input information to an emotion analysis processing unit to determine an emotional state included in the input information, generate, based on the emotional state and the input information, a prompt sentence for instructing a generative AI model to generate a text expression corresponding to the emotional state, input the prompt sentence to the generative AI model to cause the generative AI model, implemented by a neural network for natural language processing, to analyze the prompt sentence as a sequence of tokens and automatically generate a text expression in response to the prompt sentence, perform translation processing and grammatical correction processing on the generated text expression, perform post-processing on the generated text expression including removal of harmful expressions, control of text length, and unification of text format, store the post-processed text expression in a data storage unit together with related information, transmit the stored text expression to the terminal for presentation to the user, and associate and record the input information from the user, the determined emotional state, the generated prompt sentence, and the generated text expression, and use the association as control information for subsequent prompt sentence generation processing and text expression generation processing. This enables an emotion-adaptive, prompt-controlled generative text pipeline that improves the technical operation of the dialog system by increasing response appropriateness, controllability, safety, and data-driven adaptability of the generative AI model on a computer platform.

The term “system” refers to a configuration including at least one server, at least one terminal, and one or more storage units, which cooperate via a communication network to execute the processing described in the claims.

The term “processor” refers to a hardware processing unit, such as a central processing unit or another arithmetic processing device, that executes program instructions to perform the functions specified in the claims.
The term “terminal” refers to an information processing device operated by a user, such as a portable communication device, a personal computing device, or another user interface device, which transmits user input to the server and presents generated text to the user.
The term “user” refers to a human operator who inputs natural language information via the terminal and receives text expressions generated by the system.
The term “natural language input information” refers to text data expressed in a human language, such as a message, question, or statement, which is entered by the user through the terminal.
The term “preprocess” refers to performing one or more operations on the natural language input information, such as normalization, tokenization, removal of unnecessary characters, and transformation to a structured representation, prior to subsequent analysis or generation processing.
The term “structured data” refers to data in which the natural language input information is organized into a predefined representation, such as a data structure or record including fields like user identifier, timestamp, and tokenized text.
The term “emotion analysis processing unit” refers to a functional unit, implemented by software and/or hardware, that applies language analysis algorithms to the natural language input information to detect an emotional state of the user.
The term “emotional state” refers to an internal state representing a type and intensity of emotion inferred from the user's natural language input, such as anger, sadness, joy, anxiety, or neutrality.
The term “prompt sentence” refers to a control text provided as input to a generative AI model, the control text including at least a representation of the user's natural language input and explicit instructions for how the generative AI model is to generate a text expression.
The term “template information” refers to a predefined pattern or format of a prompt sentence, in which variable parts such as user input and emotional state are inserted to form a complete prompt sentence.
The term “generative AI model” refers to an artificial intelligence model configured to automatically generate a text expression in response to an input prompt sentence, the model being implemented by a neural network for natural language processing.
The term “neural network for natural language processing” refers to a machine learning model including multiple layers of interconnected computational nodes, which processes token sequences and computes probability distributions over possible output tokens.
The term “text expression” refers to a sequence of characters, tokens, or words output by the generative AI model, which is intended to serve as a response or message to be presented to the user.
The term “translation processing” refers to a process of converting a text expression from a source language to a target language using computational linguistic algorithms.
The term “grammatical correction processing” refers to a process of detecting and correcting grammatical, spelling, or syntactic errors in a text expression to improve linguistic correctness.
The term “post-processing” refers to a set of operations applied to a generated text expression after generation, including at least removal of harmful expressions, control of text length, and unification of text format.
The term “harmful expressions” refers to portions of text that may be offensive, abusive, discriminatory, unsafe, or otherwise inappropriate for presentation to the user.
The term “control of text length” refers to adjusting a generated text expression to satisfy a predetermined constraint on length, such as truncating or expanding the text to stay within a target range of characters or tokens.
The term “unification of text format” refers to adjusting stylistic or structural aspects of a text expression, such as punctuation, capitalization, paragraph structure, or markup, to conform to a predetermined format.
The term “data storage unit” refers to a storage device or storage subsystem, such as a non-volatile memory or database, that stores text expressions and related information for later retrieval and processing.
The term “related information” refers to metadata associated with a text expression, including at least the user's natural language input, the emotional state, the prompt sentence, timestamps, and identifiers.
The term “association and recording” refers to storing multiple items of information, such as the user's input information, the emotional state, the prompt sentence, and the generated text expression, in a manner that links them together in one or more records.
The term “control information” refers to stored association data that is used by the processor to influence or adjust subsequent prompt sentence generation processing and text expression generation processing.
The term “sequence of tokens” refers to an ordered list of discrete units into which text is segmented by a tokenizer, each unit corresponding to a character, subword, word, or other linguistic element.
The term “probability computation” refers to numerical calculations performed by the generative AI model to determine likelihood values of candidate tokens or token sequences, which are used to select tokens during text generation.
The term “communication purpose” refers to an intended effect or goal of a response generated by the system, such as calming an angry user, reassuring an anxious user, or providing a clear explanation.
The term “response tone” refers to a stylistic characteristic of the generated text expression, such as calm, empathetic, formal, casual, or apologetic.
The term “politeness level” refers to a degree of courtesy or formality encoded in the generated text expression according to social or cultural norms.
The term “amount of explanation” refers to the level of detail and extensiveness of information included in the generated text expression, such as whether the response is concise or highly detailed.

In one embodiment, a server cooperates with one or more terminals operated by users to provide an emotion-adaptive text generation function based on a generative AI model. The server includes at least one processor, a main memory, a non-volatile storage device, and a communication interface. The processor executes a program stored in the non-volatile storage to implement the functional units described below. The terminal includes at least a display unit, an input unit, a memory, and a communication interface. The terminal may be implemented by a mobile communication device, a personal computing device, or another information processing device.

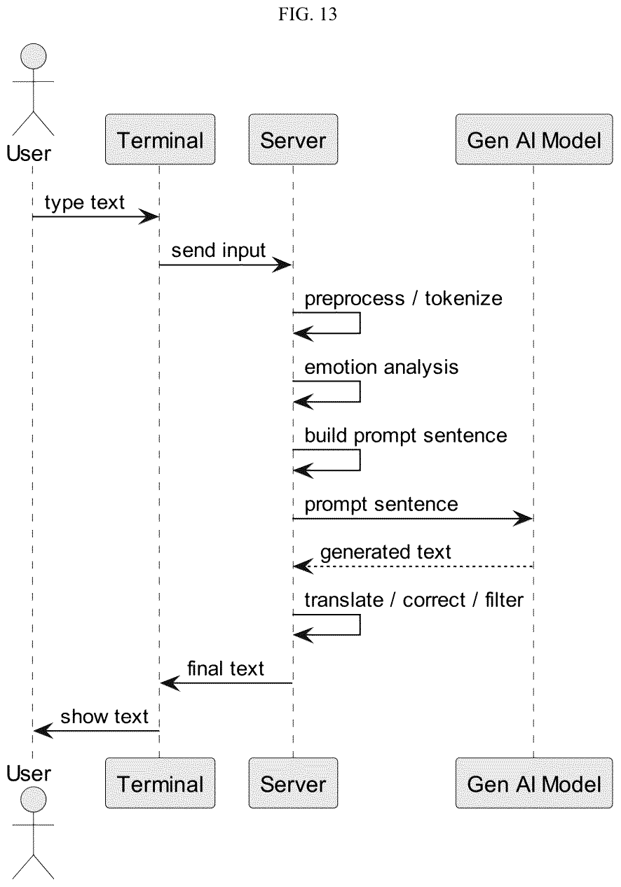

The server executes software components that may be implemented using a web application framework, a database management system, an emotion analysis library, and an interface to a generative AI model. The server may use a web server and application server configuration, such as an HTTP server component and an application framework component. The server may use a relational database management engine for storing text expressions and associated metadata. The server may call an emotion analysis software library or external emotion analysis service that applies natural language processing techniques to identify an emotional state of the user. The server may communicate with a generative AI model implemented as a large-scale neural network hosted either on the same computing environment or on a remote computing environment.
The server converts natural language input information received from the terminal into structured data. The server may represent the structured data as a record including fields such as a user identifier, a timestamp, an original text string, and intermediate processing results.
The server may store such records in a database table having columns corresponding to these fields, enabling efficient indexing and retrieval. The server uses this structured data representation to pass information between internal modules in a deterministic manner.
The server performs emotion analysis using an emotion analysis processing unit, which may be implemented as a sequence classification neural network or a transformer-based text classifier. The server tokenizes the input text into a sequence of tokens, maps the tokens to vector embeddings, and passes the embeddings to the emotion analysis model. The emotion analysis model may include multiple attention layers, feed-forward layers, and normalization layers. The model outputs a vector of scores corresponding to candidate emotional states such as anger, sadness, joy, anxiety, and neutrality. The server interprets these scores as probabilities and determines the emotional state by applying a decision rule, for example by selecting the label with the highest probability or by applying a threshold rule. The server records the selected emotional state and its probability score in the structured data associated with the user input.
The server generates a prompt sentence for a generative AI model based on the emotional state and the original user input. The server may store a plurality of prompt templates, where each template corresponds to a particular emotional state or a combination of emotional and contextual conditions. Each prompt template may include fixed text portions that describe the desired response tone, politeness level, amount of explanation, and communication purpose, as well as placeholder sections into which the server inserts the original user input or other context parameters.
For example, when the server determines that the emotional state corresponds to anger, the server may generate a prompt sentence such as:
“The user is angry. Original message: ‘Why is this so slow?!’. Please act as a polite support agent. Please generate a calm, empathetic, and apologetic response that acknowledges the delay, reassures the user, and encourages the user to wait patiently.”
   When the server determines that the emotional state corresponds to anxiety, the server may generate a prompt sentence such as:
“The user feels anxious and is worried about losing data. Original message: ‘I'm worried that I might lose all my data.’ Please generate a reassuring, clear, and informative response that explains the safety measures and gives simple steps the user can follow.”
   When the server determines that the emotional state corresponds to joy, the server may generate a prompt sentence such as:
“The user is happy. Original message: ‘This feature is amazing!’. Please generate a friendly and appreciative response that thanks the user and encourages further engagement.”
   The server embeds the user's original message into the corresponding template and constructs a complete prompt sentence as a continuous textual instruction. The server then transmits the prompt sentence to the generative AI model using an application programming interface. The server may specify generation parameters such as maximum number of tokens, sampling temperature, and decoding strategy, in order to control response diversity and length.
   The generative AI model is implemented as a neural network for natural language processing. In one embodiment, the generative AI model is a transformer-based language model including an embedding layer, a plurality of self-attention layers, feed-forward layers, and an output projection layer. The model is trained on large-scale text corpora using a language modeling objective. During training, the model minimizes a loss function such as cross-entropy between predicted token distributions and ground-truth token labels. The model updates its weights using gradient-based optimization algorithms such as stochastic gradient descent or variants thereof, processing training batches on parallel computing hardware such as graphics processing units or specialized accelerators.
   The server causes the generative AI model to analyze the prompt sentence as a sequence of tokens. The model converts the prompt sentence into token identifiers using a tokenizer, looks up token embeddings, and computes contextual representations through stacked attention and feed-forward layers. For each output position, the model computes probability distributions over possible next tokens via a softmax function. The server receives the generated tokens according to a decoding strategy, such as greedy decoding or sampling with temperature. The generated tokens form a text expression that implements the instructions encoded in the prompt sentence, such as tone control, politeness level, and explanation length.
   The server then applies translation processing and grammatical correction processing to the generated text expression. The server may use a translation model, which may be another neural network such as an encoder-decoder model, or may use a rule-based or statistical translation engine. The server converts the generated text from one language to another when necessary. The server may additionally apply a grammatical correction model that identifies and corrects linguistic errors. The grammatical correction model may be trained using parallel corpora of erroneous and corrected sentences, minimizing a loss function that measures discrepancy between model outputs and correct reference sentences.
   The server performs post-processing on the corrected text expression. The server may implement a harmful expression filter using a classifier that detects categories of harmful content. The server may tokenize the text expression, match tokens or sequences against a list of prohibited terms or patterns, and remove or replace harmful segments. The server may control the text length by truncating or expanding the response according to predetermined limits, using sentence boundary detection and token counting. The server may unify the text format by normalizing capitalization, punctuation, and whitespace according to a style guide, thereby improving readability and consistency. The server thus enforces constraints that are difficult for a human operator to apply consistently in real time.
   The server stores the resulting text expression, together with related information such as the original user input, the emotional state, the prompt sentence, timestamps, and identifiers, in a data storage unit. The server may use a relational database table having columns for user identifier, input text, emotional label, prompt text, generated text, and post-processing flags. The server may also maintain indexes on such columns to accelerate retrieval. The server uses the stored associations as control information to adjust future processing. For example, the server may analyze historical data to determine which prompt templates lead to higher user satisfaction or fewer harmful expressions, and may update template selection rules or generation parameters accordingly.
   The terminal operates as an interface device. The terminal displays an input field and output area to the user and transmits user-entered natural language text to the server via a communication network. The terminal receives a processed text expression from the server and presents it on a display device. The terminal may also render supplementary indicators such as detected emotional state or explanation level, although such indicators are optional. The terminal does not perform the main generative processing but may implement local caching or compression to reduce communication load and improve perceived responsiveness.
   The user interacts with the system by entering natural language input via the terminal and viewing the generated text expressions. The user does not need to manually specify emotional labels or formatting rules, because the server automatically analyzes the emotional state, constructs the prompt sentence, and generates an appropriate response using the generative AI model and post-processing modules. This configuration reduces cognitive load on the user and allows the system to respond in a manner that is technically optimized for emotion-aware communication.
   The described architecture improves computer technology beyond mere automation of human tasks. The server integrates emotion analysis, prompt sentence generation, neural text generation, and structured logging into a unified data flow that reduces error propagation and improves computational efficiency. By representing user inputs and generated outputs as structured records with associated emotional states and prompt texts, the server enables deterministic control paths and caching strategies. For example, the server can avoid redundant emotion analysis for repeated or similar inputs by referencing previously stored structured data, thereby reducing processing time and resource consumption.
   The server reduces communication load by transmitting compact prompt sentences and receiving compact token sequences instead of transmitting multiple intermediate representations. The server performs heavy neural computations on specialized hardware, such as parallel processors, thereby shortening response latency compared to configurations that rely on less structured, ad hoc processing. The server's post-processing modules operate on well-defined data structures, allowing efficient vectorized operations and early rejection of harmful content before it is sent to the terminal.
   The server applies decision rules and optimization procedures that are not reducible to simple human heuristics. For instance, the server may employ non-linear decision boundaries in embedding space to classify emotional states, which a human operator cannot reproduce reliably in real time. The server may also adapt prompt templates based on statistical feedback stored in the data storage unit, updating parameter values that control tone and explanation length. These computational procedures rely on high-dimensional vector representations and gradient-based optimization, which are fundamentally different from manual rule-based editing or simple automation of human responses.
   The generative AI model's internal processing is grounded in explicit algorithms: tokenization, embedding, attention computation, matrix multiplication, activation functions, loss computation, and gradient-based weight updates. The model's training uses large-scale batched data, error back-propagation, and regularization techniques such as dropout and weight decay. The server exploits these technical properties to achieve high-accuracy prediction of context-appropriate tokens, thereby improving response coherence, fluency, and emotional alignment compared to rule-based systems. Because the server directly controls the input prompt sentence structure, the server can steer the model toward specific operational regimes, such as low-temperature, safety-constrained responses for high-risk emotional states.
   In alternative embodiments, the server may implement the emotion analysis processing unit as a local library instead of an external service. The server may employ a recurrent neural network, a convolutional neural network, or a hybrid architecture to classify emotional states. The server may store templates in a configuration file, a database, or an in-memory key-value store. The server may adapt the translation and grammatical correction processing by using different models for different languages or domains. The server may modify post-processing steps by adding style adaptation, domain-specific terminology control, or personalization parameters based on user profiles.
   In another embodiment, the server may deploy multiple generative AI models and select among them depending on the emotional state or domain context. The server may route prompt sentences corresponding to anger or anxiety to a model fine-tuned for de-escalation, and route prompt sentences corresponding to neutral or joy states to a model fine-tuned for information delivery or marketing. The server may compare outputs from multiple models and select the one that best satisfies format and safety constraints, using a scoring function implemented by an evaluation module.
   Because the server systematically associates user input, emotional state, prompt sentence, and generated text expression, the server can perform offline analysis and retraining. The server can extract training examples from stored records and fine-tune the emotion analysis model or the generative AI model using supervised learning. The server may define a loss function that penalizes mismatches between desired tones and actual tones and may update the models to decrease such losses. This closed feedback loop improves the accuracy and stability of the system over time and enhances the technical performance of the computing platform.
   Through these configurations and variations, the server, terminal, and user cooperate to implement a concrete, hardware-executed method for emotion-adaptive, prompt-controlled text generation that improves the functioning of computer systems as communication platforms, beyond mere abstraction or direct automation of human mental processes.
   The following describes the processing flow using FIG. 13.

### Step 1:

The user operates the terminal and opens an application that provides a text input interface.
The terminal displays a text input field and a send control on a display unit.
The user inputs a natural language message, for example “Why is this so slow?!”, into the text input field.
The terminal treats the user's keystrokes or touch events as input and constructs a data object including at least a user identifier, a timestamp, and the input text.
The terminal outputs this data object as a request payload and transmits it to the server over a communication network using a communication protocol.
Input: user operations and typed natural language text on the terminal.
Output: a structured request payload containing the user identifier, timestamp, and natural language input, transmitted from the terminal to the server.

### Step 2:

The server receives the request payload through a communication interface.
The server parses the received payload to extract fields such as the user identifier, timestamp, and original text string.
The server validates the text by checking that the text length is within predetermined limits and that the text does not contain invalid encoding.
The server converts the text into a normalized form, for example by converting character encodings, unifying line breaks, and removing control characters.
The server stores the normalized text, the user identifier, and the timestamp in a structured record in a memory or a storage unit for later reference.
Input: structured request payload from the terminal containing the user identifier, timestamp, and raw text.
Output: a normalized text string and an associated structured record stored in the server's internal data representation.

### Step 3:

The server performs tokenization of the normalized text using a natural language processing library.
The server splits the text into tokens, such as words or subword units, and assigns token indices according to a predefined vocabulary.
The server forms a token sequence and adds meta-information such as language code and sequence length to create structured input for emotion analysis.
Input: normalized text string from Step 2.
Output: a token sequence with associated meta-information to be used as input to an emotion analysis processing unit.

### Step 4:

The server inputs the token sequence into an emotion analysis processing unit implemented by a neural network-based classifier.
The server maps each token index to a numeric embedding vector and generates a sequence of embeddings.
The server passes the embedding sequence through multiple layers of a neural network, including attention layers and feed-forward layers, to compute a contextual representation of the input.
The server obtains, from the final layer, a vector of scores representing likelihoods of multiple candidate emotional states.
The server applies a decision rule, such as selecting the emotional state corresponding to the highest score, to determine the emotional state of the user.
The server stores the determined emotional state and its confidence score in the structured record associated with the user input.
Input: token sequence and meta-information from Step 3.
Output: a determined emotional state label (for example, anger, anxiety, joy) and an associated confidence score stored in the server's record.

### Step 5:

The server selects a prompt template corresponding to the determined emotional state from a template repository.
The server inserts the original normalized text and any relevant context information into placeholder positions of the selected template.
The server appends explicit instructions describing response tone, politeness level, amount of explanation, and communication purpose to the template content to form a complete prompt sentence.
For example, when the emotional state is anger, the server generates a prompt sentence such as:
“The user is angry. Original message: ‘Why is this so slow?!’. Please act as a polite support agent. Please generate a calm, empathetic, and apologetic response that acknowledges the delay, reassures the user, and encourages the user to wait patiently.”
   The server records the generated prompt sentence in the structured record associated with the user input.
   Input: original normalized text and determined emotional state from Step 4.
   Output: a complete prompt sentence tailored to the emotional state and stored in the server's record.

### Step 6:

The server prepares a request to a generative AI model interface.
The server sets the prompt sentence as the main textual input of the request and adds generation parameters, such as maximum token count and decoding temperature.
The server transmits the request to the generative AI model over a communication channel.
The generative AI model, implemented by a neural network for natural language processing, tokenizes the prompt sentence, computes token embeddings, and iteratively predicts tokens of an output sequence via probability computation on internal layers.
The generative AI model returns a generated token sequence representing a candidate response text.
The server receives the response, decodes the token sequence into a text expression, and attaches it to the structured record.
Input: prompt sentence and generation parameters from Step 5.
Output: a generated text expression produced by the generative AI model and decoded into natural language form.

### Step 7:

The server examines the language of the generated text expression and determines whether translation is required to match a target language for the user or the terminal.
If translation is required, the server inputs the generated text into a translation module that may be based on an encoder-decoder neural network or a statistical translation engine.
The server converts the generated text from a source language to a target language by applying learned mappings between language pairs or translation rules.
The server outputs a translated text expression and stores it as an updated field in the structured record.
Input: generated text expression from Step 6 and target language information.
Output: a translated text expression in the target language, associated with the user's record.

### Step 8:

The server applies grammatical correction processing to the translated text expression.
The server inputs the text into a grammatical correction module, which may be implemented by a sequence-to-sequence neural network trained on pairs of erroneous and corrected sentences.
The server computes corrected text by minimizing a learned error measure between candidate outputs and correct language patterns.
The server outputs a grammatically corrected text expression and replaces or augments the existing text field in the structured record.
Input: translated text expression from Step 7.
Output: a grammatically corrected text expression with improved linguistic correctness.

### Step 9:

The server performs post-processing on the grammatically corrected text expression to enforce safety and format policies.
The server checks the text against a harmful expression filter using pattern matching and a classifier model to detect offensive or unsafe content.
The server removes, masks, or rephrases any detected harmful segments according to predefined rules.
The server measures the length of the text in characters or tokens and trims or expands the text to comply with predetermined length constraints.
The server normalizes formatting aspects, such as capitalization, punctuation, and whitespace, to unify the output style.
The server stores the final post-processed text expression in the structured record in the data storage unit.
Input: grammatically corrected text expression from Step 8.
Output: a post-processed text expression that satisfies safety, length, and formatting constraints and is stored in persistent storage.

### Step 10:

The server retrieves the final post-processed text expression and associated metadata from the storage unit.
The server constructs a response payload containing at least the final text expression and optionally the emotional state or additional status information.
The server transmits the response payload to the terminal via the communication interface.
Input: final post-processed text expression and metadata from Step 9.
Output: a structured response payload sent from the server to the terminal, containing the text expression to be displayed to the user.

### Step 11:

The terminal receives the response payload from the server through the communication interface.
The terminal parses the payload and extracts the final text expression to be presented.
The terminal updates a display area in the user interface to show the text expression as a system response message.
The terminal may adjust the layout or scroll position so that the user can immediately view the new message.
Input: structured response payload from Step 10.
Output: a rendered text response on the terminal display, visible to the user.

### Step 12:

The user views the displayed response on the terminal.
The user interprets the content, tone, and explanation level of the response and may decide to input an additional message.
If the user continues the interaction, the user again provides natural language input through the terminal, and the overall sequence from Step 1 onward is repeated.
Input: displayed text response on the terminal screen.
Output: user understanding of the response and optional new user input that initiates another processing cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional text generation systems that use a generative AI model typically treat user input as a flat sequence of characters or tokens and generate text solely based on semantic content. Such systems generally lack an integrated mechanism for reliably detecting a user's emotion state, incorporating that emotion state and its intensity into a prompt sentence, and controlling the downstream processing pipeline (generation, translation, correction, storage, and delivery) in a coordinated manner. As a result, conventional systems often output responses that are technically correct but emotionally inappropriate, for example, using a neutral or even cold tone when the user is anxious or angry. This mismatch can reduce user trust and satisfaction, especially in domains such as security services and support services where reassurance and de-escalation are important.

In addition, existing architectures usually perform emotion analysis, prompt construction, generative AI model invocation, translation, and correction as loosely coupled or ad-hoc steps, without a unified control flow or consistent data association. For example, emotion analysis might be done in a separate client or external tool, and the result might not be systematically tied to the prompt sentence or to subsequent correction operations. This fragmented design makes it difficult to adjust the strength of emotional expressions in a reproducible way, to systematically log the relationship between the detected emotion and the generated response, or to adapt the prompt sentence dynamically based on multiple emotion categories and their scores.
Furthermore, many known systems do not store, in a structured and queryable manner, the combination of the original user input, the detected emotion state and intensity, the constructed prompt sentence, and the generated and corrected text. Without such integrated storage, it is difficult to audit system behavior, refine prompt strategies, or improve the generative AI model usage over time based on past interactions. This limits the ability to iteratively optimize the system and to provide consistent, high-quality, emotion-aware text responses.
Therefore, there is a need for an improved computer-implemented system and server-side processing architecture that: (i) tightly integrates emotion analysis or emotion estimation with prompt sentence construction for a generative AI model; (ii) controls translation and correction processing in dependence on the detected emotion state and intensity, including explicit adjustment of emotional strength in the output text; and (iii) stores all key intermediate and final artifacts in association with identification and time information, so that the system can reliably produce, manage, and improve emotion-aware responses, particularly in security and support service contexts.

The specific processing by the specific processing unit 290 of the data processing device 12 in Application Example 2 is realized by the following means.

The present invention provides a server comprising a processor and a storage device, the processor being configured to acquire, from a user terminal via a communication path, input information including a natural language expression from a user; to perform preprocessing on the input information including at least normalization and removal of unnecessary information; to execute emotion analysis processing or emotion estimation processing based on the input information so as to specify an emotion state and an emotion intensity of the user; to construct a prompt sentence including instruction content specifying at least an output language, an output format, a tone, and a response policy based on the emotion state and the input information; to input the prompt sentence into a generative AI model that generates a text expression using a generative model and obtain a response text by an inference process of the generative AI model; to execute translation processing to convert, when necessary, at least one of the response text and a processed version of the response text into another language; to execute correction processing on at least one of the response text and a translation result, the correction processing including at least grammatical checking, expression modification, and tone adjustment; to adjust a strength of an emotional expression in the text expression during the correction processing based on at least one of the emotion state and the emotion intensity; and to store the prompt sentence, the emotion state, the response text, and a corrected text obtained by the correction processing in the storage device in association with identification information and time information, and to transmit the stored corrected text to the user terminal via the communication path to provide the stored corrected text to the user. This enables a computer-implemented text generation pipeline in which emotion analysis and emotion-dependent prompt construction are systematically integrated with generative AI inference, translation, and correction, thereby improving the technical operation of the server in generating, managing, and delivering emotion-aware text responses with controlled emotional strength and consistent logging suitable for iterative optimization and reliable deployment in security and support service environments.

The term “input information” refers to digital data including at least one natural language expression that is received from a user via a user terminal over a communication path.

The term “natural language expression” refers to a sequence of characters or tokens representing human language text, such as a sentence, phrase, or paragraph, that can be interpreted by a natural language processing system.
The term “user terminal” refers to an information processing apparatus operated by a user, such as a computing device or communication device, that provides a user interface for inputting and receiving information and that communicates with a server via a communication network.
The term “communication path” refers to a logical or physical communication channel, such as a wired or wireless network connection, over which data is transmitted between the user terminal and the server.
The term “preprocessing” refers to a set of operations applied to input information before subsequent analysis or generation, including at least normalization of the text and removal of unnecessary or noisy information.
The term “normalization” refers to processing that converts text into a standardized form, such as unifying character encodings, converting characters to a common case, or standardizing spacing and punctuation, to facilitate subsequent processing.
The term “unnecessary information” refers to portions of input information that are not required for emotion analysis, prompt construction, or text generation, such as redundant whitespace, control characters, or irrelevant metadata.
The term “emotion analysis processing” refers to processing that detects or classifies an emotional state from input information by analyzing linguistic or contextual features of a natural language expression.
The term “emotion estimation processing” refers to processing that computes, from input information, a probabilistic or numerical estimate of one or more emotion categories and their corresponding intensities.
The term “emotion state” refers to a classification or label indicating a psychological state of a user, such as anger, anxiety, joy, sadness, or stress, as determined by emotion analysis processing or emotion estimation processing.
The term “emotion intensity” refers to a quantitative value or level that represents a degree or strength of a particular emotion state associated with the user.
The term “prompt sentence” refers to a text instruction, including at least one natural language segment, that is constructed to direct a generative AI model to perform a specified generation task in accordance with defined conditions.
The term “instruction content” refers to information included in a prompt sentence that specifies how a generative AI model is to generate text, including at least an output language, an output format, a tone, and a response policy.
The term “output language” refers to a target natural language in which the generative AI model is instructed to generate the response text.
The term “output format” refers to a structural specification for generated text, such as bullet lists, paragraphs, sections, or headings, which the generative AI model is instructed to follow.
The term “tone” refers to a stylistic and emotional quality of generated text, such as polite, calm, formal, neutral, or reassuring, specified as part of the generation instructions.
The term “response policy” refers to a high-level behavioral rule or strategy that guides generated content, such as providing reassurance, de-escalating anger, explaining procedures, or acknowledging user concerns.
The term “generative AI model” refers to a computational model implementing generative algorithms, such as a neural network-based language model, configured to produce text expressions in response to input prompt sentences.
The term “generative model” refers to an algorithmic model that learns a probability distribution over sequences of symbols or tokens and is capable of generating new sequences consistent with that distribution.
The term “inference process” refers to a computational process in which a generative AI model receives a prompt sentence and produces a response text according to learned parameters without modifying those parameters.
The term “response text” refers to a text expression output by the generative AI model in response to a prompt sentence, prior to any translation or correction.
The term “translation processing” refers to processing that converts text from a source natural language into a target natural language using a translation algorithm or translation service.
The term “correction processing” refers to processing that modifies text to improve at least one of grammaticality, clarity, fluency, and appropriateness of tone, and may include automated grammar checking and expression modification.
The term “grammatical checking” refers to automatic detection and correction of errors related to syntax, morphology, or agreement in a text.
The term “expression modification” refers to alteration of wording, phrasing, or lexical choice in text to improve readability, politeness, precision, or domain suitability.
The term “tone adjustment” refers to modification of stylistic elements of text, such as politeness level or emotional warmth, to conform to a specified tone.
The term “emotional expression” refers to a portion of text that explicitly or implicitly conveys an emotion state, such as anger or anxiety, through lexical or stylistic elements.
The term “strength of an emotional expression” refers to a perceived intensity or degree of an emotion conveyed by text, such as the difference between “slightly angry” and “very angry.”
The term “adjust a strength of an emotional expression” refers to modifying a text expression so that the perceived emotional intensity is increased, decreased, or otherwise controlled in accordance with an emotion state and emotion intensity.
The term “information storage device” refers to a hardware or logical storage resource, such as a memory device or database system, configured to store digital data including prompt sentences, emotion states, and text expressions.
The term “identification information” refers to data that uniquely or logically identifies entities such as a user, a session, a message, or a transaction, enabling association and retrieval of related records.
The term “time information” refers to data indicating a temporal attribute, such as a timestamp or time interval, associated with events including input reception, processing, or storage.
The term “external emotion analysis service” refers to an emotion analysis or sentiment analysis system that is provided outside the server, for example as a network-accessible service, and is invoked to analyze input information.
The term “internal machine learning model” refers to a machine learning-based classification or regression model deployed within the server's environment and configured to perform emotion analysis or emotion estimation on input information.
The term “emotion category” refers to a predefined label representing a type of emotion, such as anger, anxiety, joy, or stress, used in classifying or quantifying an emotion state.
The term “score” refers to a numerical value associated with an emotion category, indicating a likelihood, confidence, or intensity of that emotion in relation to input information.
The term “security service” refers to a service that manages or supports protection of assets, facilities, systems, or persons, including monitoring, alert handling, and incident response.
The term “support service” refers to a service that provides assistance, guidance, or troubleshooting to users regarding products, systems, or processes.
The term “trouble-handling policy” refers to a rule set or guideline used for addressing user-reported issues or incidents, such as steps for investigation, mitigation, and follow-up communication, which can be reflected in generated responses.
The term “server” refers to an information processing apparatus or system that comprises at least one processor and at least one storage device and that executes the processing for emotion analysis, prompt construction, text generation, translation, correction, storage, and transmission to the user terminal.

In one embodiment, a server implements the claimed system as a network-connected computing apparatus that cooperates with at least one terminal operated by a user. The server includes at least one processor, a main memory, a non-volatile storage device, a network interface, and an information storage device such as a database system. The processor executes a program comprising multiple software modules that implement emotion analysis, prompt sentence construction, generative AI model invocation, translation, correction, storage, and communication with the terminal.

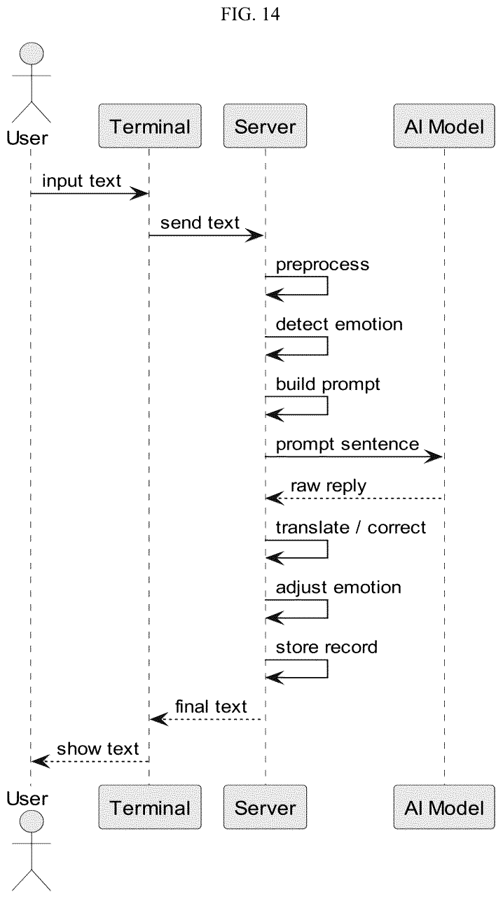

The terminal operates as a user interface device. The terminal may be realized by a smartphone, a tablet computer, a portable information processing device, a desktop computer, or a robotic device equipped with a display and an input interface. The terminal executes an application that displays a text input field and a response area and communicates with the server via a communication network such as the Internet over a wired or wireless connection. The user operates the terminal to input a natural language expression. The user may enter, for example, “I am angry”, “I am worried about recent security breaches”, or “I am stressed”. The terminal converts the user input into a structured data record including at least a text field, a language code, and a user identifier, and the terminal transmits the record to the server through a network protocol such as HTTPS. By using this client-server configuration, the system centralizes heavy computation and model execution on the server, thereby reducing computational load and power consumption on the terminal.
The server executes a preprocessing module implemented, for example, in a general-purpose programming language such as Python and using a data processing library such as a tabular data manipulation library. The server normalizes the received text by converting character encodings into a uniform encoding, unifying case (for example, converting all alphabetic characters to lowercase when appropriate), standardizing whitespace, and removing control characters and unnecessary markup. The server also removes unnecessary information, such as repeated punctuation or debug strings that may have been included by client-side logging. This normalization and noise removal produces a consistent and compact text representation that improves the stability and speed of downstream analysis and generation, reducing the likelihood of parsing errors and unnecessary tokenization overhead at the generative AI model.
The server performs emotion analysis or emotion estimation on the normalized text. In one embodiment, the server calls an external emotion analysis service via an application programming interface. The server constructs a request that includes the normalized text, sends the request to the service, and receives a response that includes one or more emotion categories and corresponding scores. The emotion categories may include, for example, anger, anxiety, joy, sadness, and stress. The scores may be numerical values between 0 and 1 representing a probability or intensity of each emotion.
In another embodiment, the server employs an internal machine learning model as an emotion engine. The server stores this model on a storage device and loads it into memory during operation. The emotion engine may be implemented as a neural network architecture, such as a transformer-based encoder that processes tokenized text and outputs a vector of emotion probabilities. The server uses a tokenizer to segment the text into tokens according to a vocabulary and converts the tokens into embedding vectors. The neural network applies multiple layers of self-attention and feed-forward transformations with learned weights and activation functions. During training, the server or an external computing environment has optimized the weights by minimizing a loss function such as cross-entropy loss between predicted emotion distributions and labeled emotion data, using a gradient-based algorithm such as stochastic gradient descent or an adaptive variant. The training may include regularization methods such as dropout and data augmentation such as synonym replacement or sentence reordering to improve generalization.
At runtime, the server passes the tokenized input to the emotion engine, computes forward propagation through the neural network, and obtains a probability distribution over emotion categories. The server selects, for example, the category with the highest probability as the emotion state and also stores the corresponding probability as the emotion intensity. By using this learned model, the server can detect nuanced emotional cues that are not easily captured by simple rule-based systems, thereby increasing emotion classification accuracy and reducing false detections. This improved emotion recognition supports more precise downstream prompt construction and text generation.
The server then constructs a prompt sentence for a generative AI model. The processor accesses a prompt template repository stored in the information storage device. The repository may include text templates indexed by emotion state, domain, and task type. Each template specifies instruction content such as the output language, the desired output format, the tone, and a response policy. The server selects or composes a template corresponding to the recognized emotion and the application context.
For example, when the emotion state is anxiety and the context is a security-related service, the server may construct the following prompt sentence:
“The user is anxious about a possible security issue. User message: ‘I am worried about recent security breaches.’ Generate a concise, polite response in Japanese that reassures the user and briefly explains the security monitoring measures in simple language. Use a calm and trustworthy tone.”
   When the emotion state is anger, the server may construct a prompt such as:
“The user wrote ‘I am angry’ in English. First, translate this sentence into Japanese. Then soften the emotional intensity so that it becomes equivalent to ‘I am a little angry’ while still honestly acknowledging the emotion. Output only the final Japanese sentence.”
   When the emotion state is stress and the task is content recommendation, the server may construct a prompt such as:
“User emotion: stress. User message: ‘I am stressed.’ Suggest three types of relaxing content in Japanese, such as music, meditation, or breathing exercises. Use bullet points and briefly explain why each content helps the user relax.”
   The server can dynamically alter specific clauses of these templates based on the emotion intensity scores. For example, if anger intensity is high, the server explicitly instructs the generative AI model to further soften the tone, whereas if anger intensity is low, the server may preserve a more neutral expression.
   The server inputs the constructed prompt sentence into a generative AI model. In one embodiment, the generative AI model is a neural network-based language model implementing an autoregressive transformer architecture. The generative AI model has been trained on large-scale text data to predict the next token in a sequence given preceding tokens. During training, the model parameters are updated by minimizing a token-level prediction loss, such as cross-entropy loss, using a gradient-based optimization algorithm. The model comprises a stack of transformer blocks, each including multi-head self-attention and position-wise feed-forward sublayers. Positional encodings indicate the order of tokens. The model maintains attention weights that allow it to attend selectively to relevant parts of the context when generating text.
   The server communicates with the generative AI model via a defined programmatic interface. The server transmits the prompt sentence as a sequence of tokens along with generation parameters, such as a temperature parameter that controls sampling randomness, a maximum token limit that restricts response length, and possibly a top-k or nucleus sampling threshold that limits the candidate token set at each step. The generative AI model computes, in its inference process, the conditional probability distribution over the next token for each generation step and samples or selects tokens until a stopping condition is met. The server receives the generated response text as the concatenation of these tokens decoded into characters.
   The server then optionally executes translation processing. In one embodiment, the server calls an external machine translation service via a translation API and sends the generated text with a target language code. The translation service applies its own neural network-based translation model to convert the text from the source language to the target language, and the server receives the translated text. By offloading translation to a specialized service, the server can support multiple language pairs without embedding additional large models locally while still maintaining a unified control flow.
   Next, the server performs correction processing on at least one of the response text and the translation result. The correction processing may be implemented by a grammar-checking module. In one embodiment, the server calls an external grammar and style correction service. In another embodiment, the server uses an internal transformer-based sequence-to-sequence model fine-tuned on parallel corpora of erroneous and corrected sentences. The correction module identifies grammatical errors, awkward phrases, and tone inconsistencies, and outputs a modified text. The server can specify in the correction request that the tone must be polite, calm, or encouraging, thereby aligning the corrected text with the tone specified in the prompt sentence.
   Within the correction processing, the server adjusts the strength of emotional expression based on the previously determined emotion state and emotion intensity. For example, if the user input “I am angry” and the emotion intensity is high, the server instructs the correction module or a second invocation of the generative AI model to reduce the intensity. A prompt sentence for this secondary adjustment may be:
“Original sentence: ‘I am angry.’ Translate this into Japanese and soften the tone so that it expresses only slight anger. Output only the final Japanese sentence.”
   By using this two-stage process, where emotion recognition guides both primary response generation and secondary emotional intensity adjustment, the server can precisely control the emotional profile of the output text. This control is not merely a human-like rewriting; it reflects a systematic computation where emotion scores influence prompt selection and correction parameters, leading to consistent behavior across many different inputs.
   The server stores, in the information storage device, a set of records that include at least the original input text, the normalized text, the emotion state, the emotion intensity, the constructed prompt sentence, the raw response text from the generative AI model, any translation result, the final corrected text, and associated identification and time information.
   The server may use a relational database management system. The server organizes these records in tables indexed by user identifier and message identifier. This structured storage allows the server to efficiently retrieve past interactions, analyze performance, and refine prompt templates or model parameters over time. Because all intermediate artifacts are preserved, the server can perform offline analysis to measure how specific emotion states correlate with user satisfaction, and to update prompt strategies in a data-driven manner.
   The server transmits the final corrected text to the terminal. The terminal receives the final text and displays it to the user as an assistant response. For example, the terminal may show the following text:
“I am a little angry”
   or
“Please be assured that the system is continuously monitored, and that immediate action will be taken if an abnormality is detected.”
   By delivering responses that reflect not only the semantic content but also controlled, appropriate emotional tone, the system improves user trust and perceived quality of service, particularly in sensitive applications such as security monitoring and technical support.
   This architecture and processing sequence provide technical improvements over conventional systems. Because the server performs emotion analysis, prompt sentence construction, generation, translation, and correction in a single integrated pipeline with explicit data structures and logging, the server can avoid redundant data conversions and repeated network calls, thereby reducing processing latency and communication load. For example, the server performs emotion analysis only once per user message and reuses the resulting emotion state and intensity values to drive both the prompt construction and the correction stages. By caching emotion results and prompt templates, the server reduces repeated computation and accelerates response time.
   Moreover, by normalizing input text and applying consistent preprocessing before tokenization, the server reduces the effective vocabulary footprint and ambiguity presented to the generative AI model, which can lower the number of active tokens and simplify the internal attention computation. This yields an improvement in computational efficiency and can reduce inference time and resource usage.
   The integrated storage of intermediate artifacts allows the server to implement feedback loops that refine internal models and prompt templates based on aggregate error statistics. For instance, the server can periodically analyze stored records to identify cases where the correction module frequently adjusts grammar or tone in a particular pattern. The server can then encode these patterns directly into custom prompt templates or post-processing rules, reducing future correction load. This self-improving behavior enhances the accuracy and consistency of the system over time.
   The emotion engine and generative AI model operate according to learned mathematical rules derived from training data and optimization processes, which differ fundamentally from human editing or rule-based text rewriting. The neural network models apply high-dimensional vector computations, attention mechanisms, and gradient-based parameter updates that are not feasible for a human operator to implement manually at scale or in real time. By combining these models with specific prompt sentences that incorporate emotion states and intensities as control signals, the server utilizes the models in a non-conventional way that improves computer operation: it transforms an otherwise generic text generator into a configurable, emotion-sensitive engine with explicit control channels.
   The system further provides multiple variations and alternative configurations. In one variation, the server executes the generative AI model locally on specialized hardware such as graphical processing units, while the emotion analysis is performed by an external service. In another variation, the server executes both the emotion engine and the generative AI model locally and uses external services only for translation. In yet another variation, the correction processing is integrated into the generative AI model itself via an extended prompt sentence, such as:
“User emotion: anxiety. User message: ‘I am worried about recent security breaches.’ Generate a response in Japanese that both reassures the user and is already grammatically correct and polite. Do not output any meta-commentary.”
   These variants all conform to the claimed architecture in that the server uses the emotion state and intensity to configure the prompt sentence, invokes a generative AI model, and performs correction and storage operations in a coordinated manner.
   Through these configurations and operations, the server improves the technical field of computer-implemented natural language processing by enabling more accurate emotion-conditioned generation, more efficient data handling, and more controllable and auditable system behavior than conventional systems that perform only generic text generation without integrated emotion control or structured logging of prompt sentences and related processing results.
   The following describes the processing flow using FIG. 14.

### Step 1:

The user operates the terminal to input a natural language expression.
The user enters text such as “I am angry” or “I am worried about recent security breaches” into a text input field of an application running on the terminal.
The terminal receives the raw text as input and creates a structured message object including at least a text field, a language field, and a user identifier. The terminal performs simple client-side validation, such as checking that the text is not empty. The terminal outputs a structured request that encapsulates the user text, the language code, and metadata, and transmits this request to the server via a network protocol such as HTTPS.

### Step 2:

The server receives the request from the terminal.
The server accepts the HTTP request at a predefined endpoint, and the input to this step is the structured request including the natural language text and metadata. The server parses the request body (for example, JSON) and extracts the text string, the language code, the user identifier, and a timestamp. The server then stores a preliminary log entry in an information storage device, recording the raw input and metadata for traceability. The server outputs a normalized internal data structure representing the incoming message, which will be passed to subsequent processing modules.

### Step 3:

The server performs preprocessing on the input text.
The input to this step is the extracted text string and associated metadata. The server executes a preprocessing module implemented, for example, with a text processing library. The server converts the text to a standard character encoding, normalizes whitespace, removes control characters, and optionally converts alphabetic characters to a consistent case. The server may also strip debugging tags or irrelevant markup. As part of data processing, the server applies deterministic string operations such as trimming, regular expression-based replacements, and Unicode normalization. The output of this step is a cleaned and normalized text string that is more suitable for tokenization and emotion analysis.

### Step 4:

The server executes emotion analysis or emotion estimation.
The input to this step is the normalized text produced in Step 3. In one configuration, the server calls an external emotion analysis service by constructing a request that includes the normalized text and sending it over a network interface. The external service returns a set of emotion categories and corresponding scores. In another configuration, the server uses an internal machine learning model: the server tokenizes the text, converts tokens to embeddings, and propagates them through a neural network that computes a probability distribution over emotion categories. In both cases, the server processes the returned scores by selecting the highest-scoring emotion as the emotion state and storing the associated score as the emotion intensity. The output of this step is a structured emotion descriptor including at least an emotion label (for example, anger or anxiety) and a numerical intensity value.

### Step 5:

The server selects or constructs a prompt sentence template.
The input to this step is the emotion descriptor from Step 4 and the normalized text from Step 3. The server consults a prompt template repository stored in an information storage device.
The server uses the emotion label and application context to retrieve an appropriate template or compose one from several parts. For example, for anxiety in a security context, the server selects a template that includes instructions for reassurance and explanation. The server performs data retrieval operations on the repository and assembles a base prompt containing placeholders such as {emotion}, {user_message}, {output_language}, and {tone}. The output of this step is a partially specified prompt template ready for parameter substitution.

### Step 6:

The server generates a concrete prompt sentence.
The input to this step is the partially specified template and the actual values: emotion label, emotion intensity, normalized text, and desired output language. The server replaces each placeholder in the template with the corresponding value using string substitution operations.
For example, the server builds a prompt such as:
“The user is anxious about a possible security issue. User message: ‘I am worried about recent security breaches.’ Generate a concise, polite response in Japanese that reassures the user and briefly explains the security monitoring measures in simple language. Use a calm and trustworthy tone.”
   The server can also modify the prompt content based on the emotion intensity, for example, by adding a clause to strongly soften the tone when intensity is high. The output of this step is a fully constructed prompt sentence in natural language, which will be supplied to the generative AI model.

### Step 7:

The server prepares a request for the generative AI model.
The input to this step is the constructed prompt sentence from Step 6. The server tokenizes the prompt according to the generative AI model's vocabulary and constructs a request payload including the tokens, model identifier, and generation parameters such as temperature, maximum token count, and sampling parameters. The server structures this payload according to the interface specification of the generative AI model service. The data processing here includes mapping text to token IDs and assembling a parameter object. The output of this step is a complete model request object ready to be transmitted to the generative AI model execution environment.

### Step 8:

The server invokes the generative AI model and obtains a response text.
The input to this step is the model request object prepared in Step 7. The server sends this request to a generative AI model endpoint over a network connection. The generative AI model performs its internal inference: it processes the prompt tokens through an autoregressive transformer network to compute conditional probability distributions for successive tokens and generates a sequence representing the response. The server receives a response that includes generated token IDs or text. The server decodes the tokens back into a character string and trims any leading or trailing whitespace. The output of this step is the raw response text produced by the generative AI model.

### Step 9:

The server performs optional translation processing.
The input to this step is the raw response text and the desired target language. If the language of the response text does not match the user's preferred language or a system-specified language, the server invokes a translation module. The server calls an external translation service or an internal translation model and passes the response text and target language. The translation module applies its translation algorithm to convert the text from the source language to the target language. The server receives the translated text and may perform basic sanitation, such as removing unwanted tags. The output of this step is a translated response text in the correct output language. If translation is not needed, the output is simply the original response text.

### Step 10:

The server executes correction processing on the response text.
The input to this step is the translated or original response text. The server passes this text to a correction module, which may be an external grammar-checking service or an internal neural sequence-to-sequence model. The correction module analyzes the text to detect grammatical errors, awkward phrases, and inconsistencies with the required tone. The server receives suggested corrections, and applies them by editing the text at specified positions, modifying words, and adjusting punctuation. The server may iteratively apply corrections until no further changes are proposed or a maximum number of passes is reached. The output of this step is a grammatically corrected and stylistically refined text.

### Step 11:

The server adjusts the strength of emotional expression.
The input to this step is the corrected text from Step 10 and the emotion descriptor from Step 4. The server determines whether the emotional intensity in the text should be increased, decreased, or maintained based on system rules. For example, when the emotion label is anger and the intensity is high, the server decides to reduce the expression strength. The server may construct a secondary prompt sentence that describes how to alter the emotional intensity, such as:
“Original sentence: ‘I am angry.’ Translate this into Japanese and soften the tone so that it expresses only slight anger. Output only the final Japanese sentence.”
   The server sends this secondary prompt and the original expression to the generative AI model or a specialized tone-adjustment model. The model returns a modified expression with adjusted emotional strength. The server replaces the relevant part of the text with this modified expression. The output of this step is a final text whose emotional tone is controlled in accordance with the detected emotion state and intensity.

### Step 12:

The server stores intermediate and final data in an information storage device.
The input to this step is the original user text, the normalized text, the emotion descriptor, the constructed prompt sentence, the raw response text, the translated text if present, and the final corrected and emotion-adjusted text, along with identification information and time information. The server creates a record structure containing these fields and writes the record into a database using an insertion operation. The server may also create indexes on the user identifier and timestamp fields for efficient retrieval. The data processing involves serialization of structured objects into database rows and the execution of database commands. The output of this step is a persistent log entry that can be queried for auditing, analytics, or further tuning of the system.

### Step 13:

The server transmits the final text to the terminal.
The input to this step is the final corrected and emotion-adjusted text produced in Step 11 and possibly selected metadata from the stored record. The server encapsulates the final text and metadata in a response message formatted for the terminal, such as a JSON structure containing a “message” field and an “emotion” field. The server sets appropriate HTTP headers and sends the response back to the terminal over the communication path. The output of this step is a network response carrying the final text and additional information.

### Step 14:

The terminal receives and displays the final text to the user.
The input to this step is the server response received via the network. The terminal parses the response message, extracts the final text and any associated metadata such as the recognized emotion. The terminal updates its user interface by inserting the final text into a display area, such as a chat bubble, and may display the emotion state as an icon or color. The terminal may also store the displayed text in a local log for the current session. The output of this step is a visual presentation of the final text on the terminal display, accessible to the user for reading.

### Step 15:

The user reviews the response and optionally initiates further interaction.
The input to this step is the displayed final text. The user reads the content and evaluates whether the response is satisfactory or whether additional clarification or assistance is needed. Based on this evaluation, the user may input another natural language expression into the terminal, such as “Thank you, but the alarm is still making noise.” This new input constitutes new input information, which the terminal again structures and transmits to the server. The output of this step is a new user input that re-enters the processing flow starting from Step 1, enabling continuous dialogue with emotion-aware responses.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naëve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

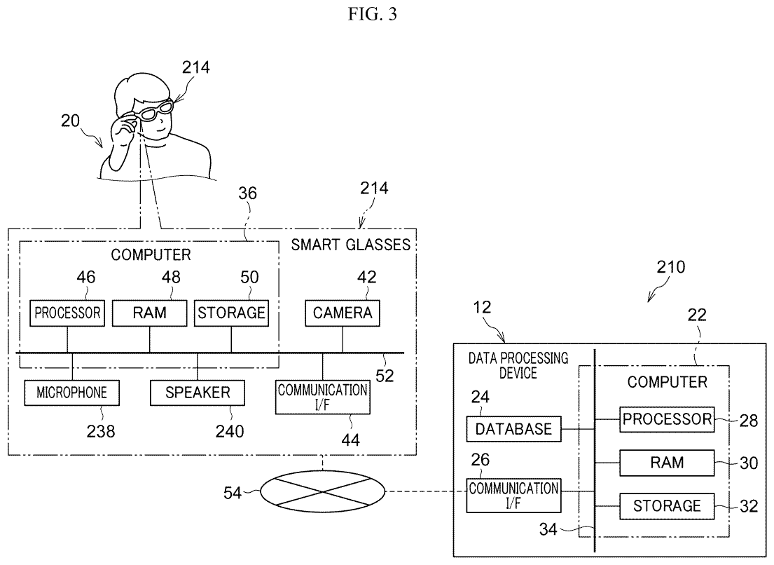

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

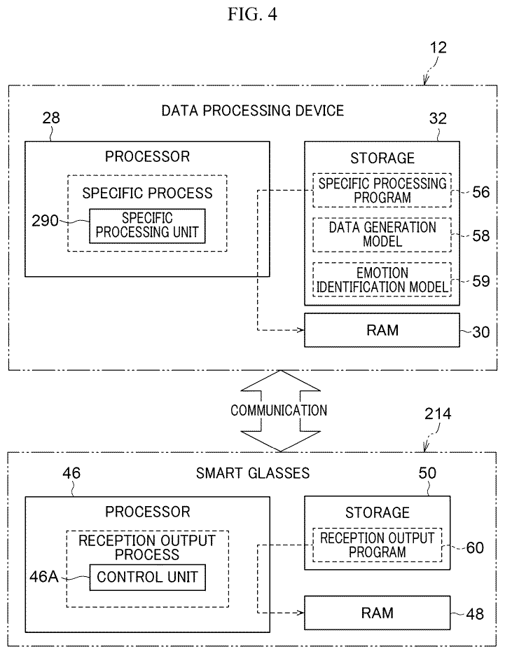

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naëve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

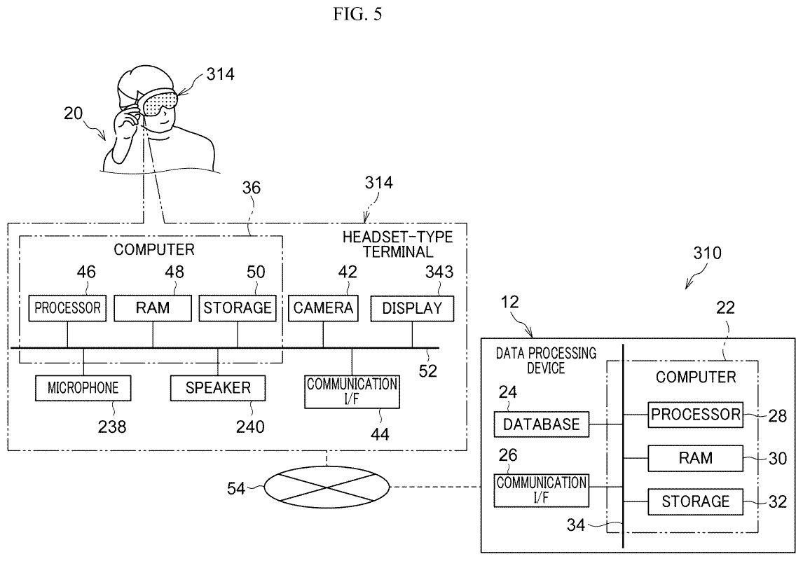

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

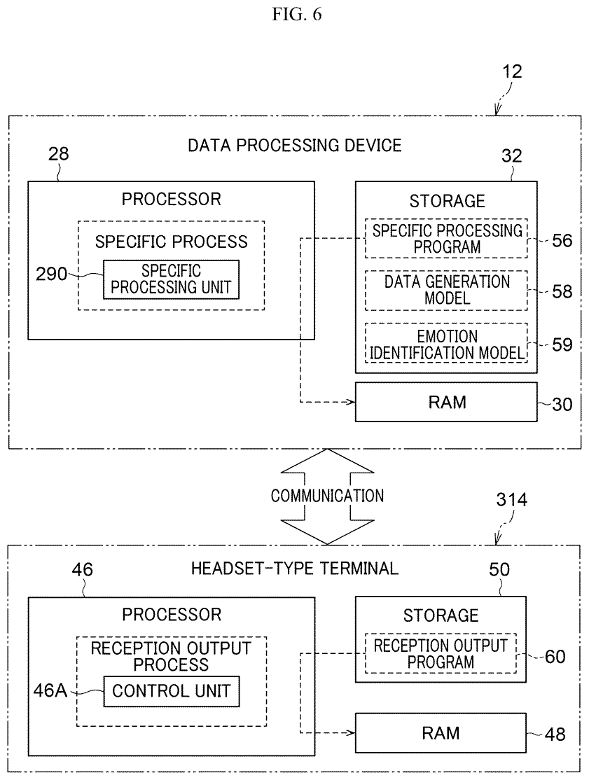

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

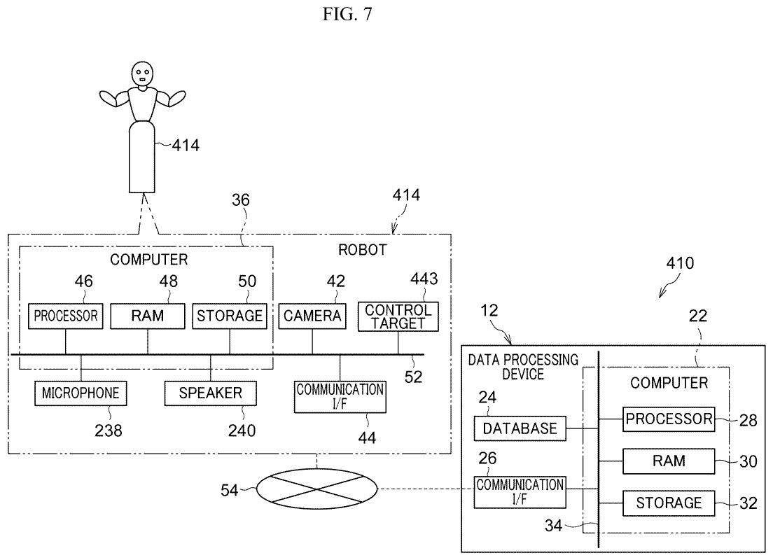

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

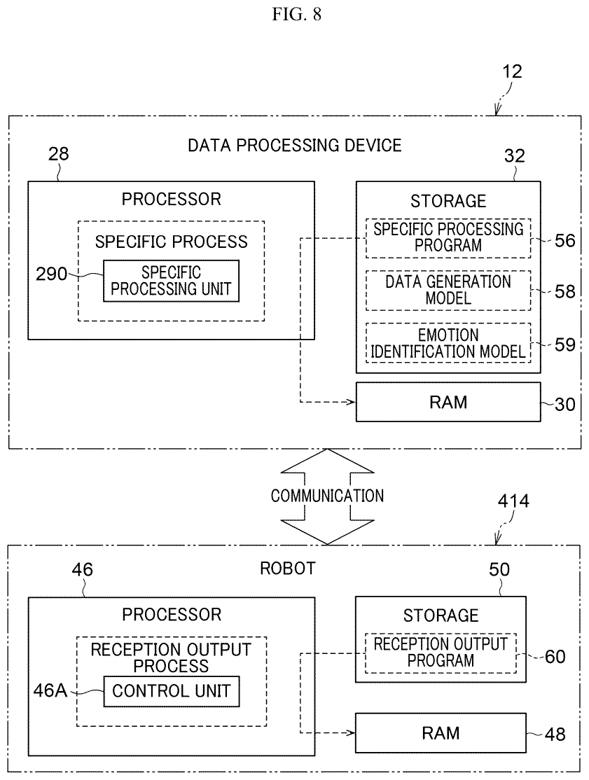

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

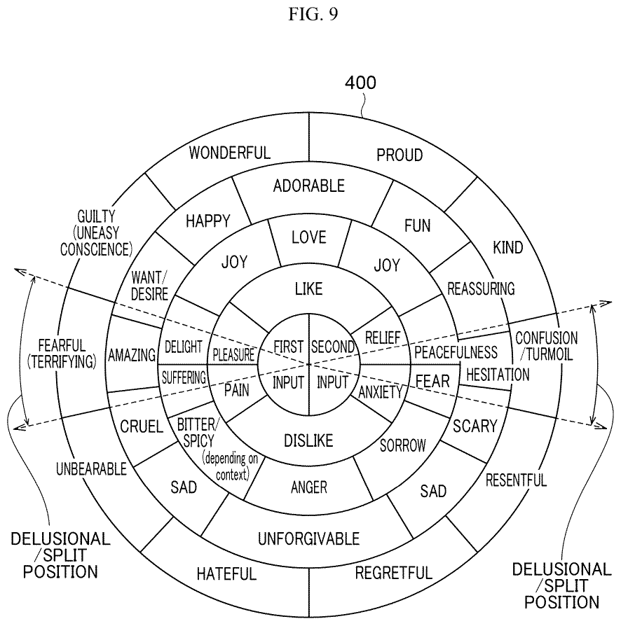

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

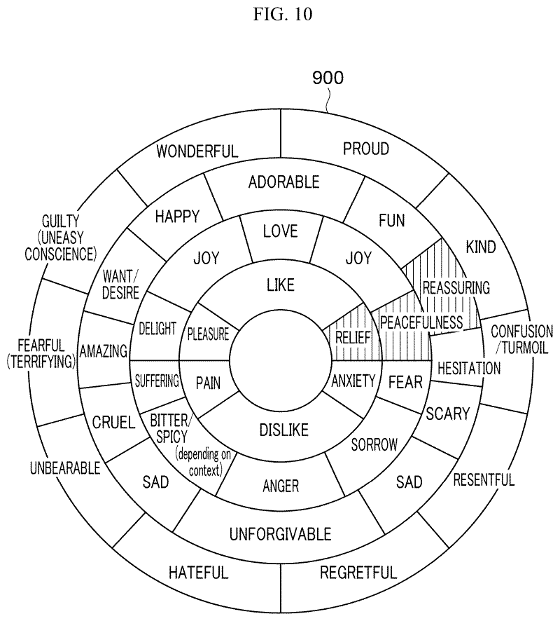

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a terminal, input information including character information expressing an emotion of a user,
perform preprocessing on the input information to generate preprocessed character information, the preprocessing including at least a character string normalization process, an unnecessary character removal process, and a language determination process,
generate, on the basis of the preprocessed character information and information relating to an emotional state of the user, a prompt sentence to be used as input to a generative AI model, the prompt sentence including at least a translation instruction and an emotion intensity adjustment instruction,
transmit the prompt sentence to an external processing apparatus that executes the generative AI model, and acquire a text output generated by the generative AI model in response to the prompt sentence,
perform correction processing on the text output to generate corrected text information, the correction processing including at least a translation process to a target language and an emotion intensity adjustment process corresponding to the emotional state of the user,
store, in a storage medium as structured data, the corrected text information in association with the input information and management information relating to the prompt sentence, and provide the corrected text information to the user by acquiring the corrected text information from the storage medium on the basis of a retrieval condition and transmitting the corrected text information to the terminal.

### Supplementary 2

The system according to supplementary 1,
wherein the processor is configured to
include, in the prompt sentence, generation conditions and output format conditions that specify that the generative AI model performs neural network type generation processing to generate the text output in response to the prompt sentence.

### Supplementary 3

The system according to supplementary 1,
wherein the processor is configured to
generate and transmit, by using the text output acquired from the generative AI model as input, a second prompt sentence to the generative AI model in order to obtain a modified text in which at least one of emotional strength, writing style, and politeness level is automatically adjusted, and store the modified text in the storage medium as the corrected text information.

### Application Example 1

### Supplementary 1

A system comprising a processor,
wherein the processor is configured to
receive input information in a natural language from a user,
preprocess the input information to normalize the input information as text data,
generate a prompt sentence based on the text data, the prompt sentence being for causing a generative artificial intelligence model to execute translation processing and sentiment-degree adjustment processing,
input the prompt sentence to the generative artificial intelligence model via a network and obtain response data including a translated text and a sentiment-adjusted text from the generative artificial intelligence model,
store the translated text and the sentiment-adjusted text obtained from the response data in a data management apparatus,
generate distribution data for distributing the translated text and the sentiment-adjusted text stored in the data management apparatus to terminals of other users, and provide the distribution data to the other users, and
execute communication control such that the translated text and the sentiment-adjusted text are presentable in real time to at least one of the user and the other users.

### Supplementary 2

The system according to supplementary 1,
wherein the processor is configured to
form the prompt sentence as a sentence including an instruction to the generative artificial intelligence model, which uses a neural network to generate text in response to an input prompt sentence, to execute, in combination, translation processing, expression-correction processing, and sentiment-degree adjustment processing for the text data.

### Supplementary 3

The system according to supplementary 1,
wherein the processor is configured to
generate the prompt sentence based on a sentiment degree included in the input information from the user and a target sentiment degree required for presentation to a recipient, and
instruct the generative artificial intelligence model to generate, for a translation result of the input information, a sentiment-adjusted text whose sentiment expression is adjusted to match the target sentiment degree.

### Example 2

### Supplementary 1

A system comprising a processor,
wherein the processor is configured to
receive natural language input information from a user via a terminal,
preprocess the input information while converting the input information into structured data,
input the preprocessed input information to an emotion analysis processing unit and determine an emotional state included in the input information,
generate, on the basis of the emotional state and the input information, a prompt sentence for instructing a generative AI model to generate a text expression corresponding to the emotional state,
input the prompt sentence to the generative AI model and cause the generative AI model to generate a text expression in response to the prompt sentence,
perform translation processing and grammatical correction processing on the generated text expression,
store the text expression subjected to the translation processing and the grammatical correction processing in a data storage unit together with related information,
transmit the stored text expression to the terminal and present the stored text expression to the user, and
associate and record the input information from the user, the emotional state, the prompt sentence, and the generated text expression, and use the association as control information for subsequent prompt sentence generation processing and text expression generation processing.

### Supplementary 2

The system according to supplementary 1,
wherein the processor is configured to generate the prompt sentence by embedding the input information into template information corresponding to the emotional state, and to include, in the prompt sentence, instructions regarding response tone, politeness level, amount of explanation, and communication purpose.

### Supplementary 3

The system according to supplementary 1,
wherein the processor is configured to cause the generative AI model, implemented by a neural network for natural language processing, to analyze the prompt sentence as a sequence of tokens and automatically generate a text expression by performing probability computation on the sequence of tokens using computing resources, and to perform post-processing on a response text expression received from the generative AI model, the post-processing including removal of harmful expressions, control of text length, and unification of text format.

### Application Example 2

### Supplementary 1

A system comprising a processor,
wherein the processor is configured to
acquire, from a user terminal via a communication path, input information including a natural language expression from a user,
perform preprocessing on the input information, the preprocessing including at least normalization and removal of unnecessary information,
execute emotion analysis processing or emotion estimation processing based on the input information so as to specify an emotion state and an emotion intensity of the user,
construct a prompt sentence including instruction content specifying at least an output language, an output format, a tone, and a response policy, based on the emotion state and the input information,
input the prompt sentence into a generative AI model that generates a text expression using a generative model, and obtain a response text by an inference process of the generative AI model,
execute translation processing to convert, when necessary, at least one of the response text and a processed version of the response text into another language,
execute correction processing on at least one of the response text and a translation result, the correction processing including at least grammatical checking, expression modification, and tone adjustment,
adjust a strength of an emotional expression in the text expression in the correction processing, based on at least one of the emotion state and the emotion intensity,
store the prompt sentence, the emotion state, the response text, and a corrected text obtained by the correction processing in an information storage device in association with identification information and time information, and
transmit the stored corrected text to the user terminal via the communication path and provide the stored corrected text to the user.

### Supplementary 2

The system according to supplementary 1,
wherein the processor is configured to
execute the emotion analysis processing or the emotion estimation processing by using at least one of an external emotion analysis service and an internal machine learning model so as to calculate a plurality of emotion categories and a score for each of the emotion categories from the input information, and to change contents of the prompt sentence in accordance with at least one of the emotion categories and the scores.

### Supplementary 3

The system according to supplementary 1,
wherein the processor is configured to
control construction of the prompt sentence such that, when the input information relates to at least one of a security service and a support service, and when the emotion state includes at least one of anxiety and anger, the prompt sentence instructs the generative AI model to generate the response text including at least one of an explanation providing reassurance to the user, an expression of appreciation, and an indication of a trouble-handling policy.

What is claimed is:

1. A system comprising:
circuitry configured to:
acquire, via a communication interface coupled to a packet-switched network, input data comprising a sequence of character symbols transmitted from a terminal device;
perform preprocessing on the input data to generate preprocessed text data;
construct a prompt data structure comprising the preprocessed text data and control parameters, and transmit the prompt data structure to a generative neural network model to obtain response data comprising a generated text sequence;
perform correction processing on the generated text sequence to generate corrected text data;
store the corrected text data in a storage device in association with the input data and management data relating to the prompt data structure; and
transmit the corrected text data to the terminal device via the packet-switched network.

2. The system according to claim 1, wherein the circuitry is configured to construct the prompt data structure by including in the prompt data structure generation conditions specifying a processing task for the generative neural network model and output format conditions specifying a structure of the generated text sequence.

3. The system according to claim 2, wherein the circuitry is configured to include in the prompt data structure a target language parameter specifying a language of the generated text sequence and a tone control parameter specifying a stylistic quality of the generated text sequence.

4. The system according to claim 3, wherein the circuitry is configured to generate a second prompt data structure by using the generated text sequence obtained from the generative neural network model as input, and transmit the second prompt data structure to the generative neural network model to obtain modified text data in which at least one of an emotional strength, a writing style, and a politeness level of the generated text sequence is adjusted.

5. The system according to claim 4, wherein the circuitry is configured to acquire the corrected text data from the storage device on the basis of a retrieval condition comprising at least one of a user identifier, a time range, and a keyword, and transmit the acquired corrected text data to the terminal device as history data for reuse in subsequent processing.

6. The system according to claim 1, wherein the circuitry is configured to analyze the input data to determine an emotional state associated with the input data, and include an emotion parameter derived from the determined emotional state in the prompt data structure transmitted to the generative neural network model.

7. The system according to claim 6, wherein the circuitry is configured to select a prompt template from a plurality of stored prompt templates on the basis of the determined emotional state, and embed the preprocessed text data into the selected prompt template to construct the prompt data structure, the prompt template including instructions regarding at least a response tone, a politeness level, an amount of explanation, and a communication purpose corresponding to the determined emotional state.

8. The system according to claim 7, wherein the circuitry is configured to determine the emotional state by inputting the input data into an emotion analysis model that outputs a plurality of emotion categories and a score for each of the emotion categories, select the emotional state corresponding to a highest score among the plurality of emotion categories, and adjust the correction processing on the basis of at least one of the emotional state and an emotion intensity represented by the score so as to control a strength of an emotional expression in the corrected text data.

9. The system according to claim 1, wherein the correction processing comprises at least a language conversion process that converts the generated text sequence from a source language to a target language and an expression modification process that adjusts vocabulary and phrasing of the generated text sequence.

10. The system according to claim 9, wherein the circuitry is configured to generate distribution data on the basis of the corrected text data stored in the storage device, and transmit the distribution data to a plurality of terminal devices via the packet-switched network using a push communication mechanism so that at least one recipient terminal device receives the corrected text data in substantially real time.

11. The system according to claim 10, wherein the circuitry is configured to determine a target sentiment degree for each of the plurality of terminal devices on the basis of a conversation policy or a recipient profile, and include the target sentiment degree in the prompt data structure so that the generative neural network model generates a sentiment-adjusted text whose emotional expression is adjusted to match the target sentiment degree for each recipient.

12. The system according to claim 1, wherein the correction processing comprises grammatical correction processing that detects and corrects syntactic and morphological errors in the generated text sequence by using a sequence-to-sequence correction model.

13. The system according to claim 12, wherein the circuitry is configured to perform post-processing on the corrected text data, the post-processing comprising filtering of prohibited expression patterns by matching tokens against a stored exclusion list, enforcement of a predetermined text length constraint, and normalization of capitalization, punctuation, and whitespace to conform to a predetermined format specification.

14. The system according to claim 1, wherein the circuitry is configured to associate and record, in the storage device, the input data, an emotional state determined from the input data, the prompt data structure, and the corrected text data as a linked record, and use the linked record as control information for adjusting construction of subsequent prompt data structures.

15. The system according to claim 14, wherein the circuitry is configured to analyze a plurality of linked records stored in the storage device to identify a correlation between prompt data structure configurations and a quality metric of the corrected text data, and update a prompt template selection rule or a generation parameter on the basis of the identified correlation to improve accuracy of subsequent correction processing.

16. The system according to claim 1, wherein the circuitry is configured to perform the preprocessing by converting a character encoding of the input data to a standardized encoding, normalizing character forms, and removing tokens corresponding to control codes, redundant whitespace, or extraneous symbols to generate the preprocessed text data.

17. The system according to claim 16, wherein the circuitry is configured to determine a language of the preprocessed text data by computing character n-gram frequency statistics or by applying a language detection model, and include a source language identifier derived from the determined language in the prompt data structure.

18. A system comprising:
circuitry configured to:
acquire, via a communication interface coupled to a packet-switched network, input data comprising a sequence of character symbols from a terminal device, convert a character encoding of the input data to a standardized encoding, normalize character forms, remove tokens corresponding to control codes and redundant whitespace, and determine a source language of the input data by computing character n-gram frequency statistics to generate preprocessed text data;
input the preprocessed text data into an emotion analysis model comprising a Transformer-based encoder that computes attention weights over token embeddings using scaled dot-product attention and softmax normalization to output a probability distribution over a plurality of emotion categories, and determine an emotional state and an emotion intensity from the probability distribution;
construct a prompt data structure comprising the preprocessed text data, the emotional state, an emotion intensity parameter, a target language parameter, a tone control parameter, and generation conditions, select a prompt template from a plurality of stored prompt templates on the basis of the emotional state, embed the preprocessed text data into the selected prompt template, and transmit the prompt data structure to a generative neural network model comprising a Transformer-based decoder that predicts successive output tokens via softmax probability computation to obtain response data comprising a generated text sequence;
perform correction processing on the generated text sequence, the correction processing comprising language conversion from a source language to a target language, grammatical error detection and correction using a sequence-to-sequence model, expression modification to adjust vocabulary and phrasing, and adjustment of a strength of an emotional expression on the basis of the emotion intensity to generate corrected text data;
store the corrected text data in a storage device in association with the input data, the emotional state, the prompt data structure, and time information as a linked record; and
transmit the corrected text data to the terminal device via the packet-switched network.

19. The system according to claim 18, wherein the circuitry is configured to generate a second prompt data structure by using the generated text sequence as input, include in the second prompt data structure an instruction to adjust at least one of the emotional strength, a writing style, and a politeness level, transmit the second prompt data structure to the generative neural network model to obtain modified text data, and adopt the modified text data as the corrected text data.

20. A method performed by circuitry of a server coupled to a packet-switched network via a communication interface, the method comprising:
acquiring, via the communication interface, input data comprising a sequence of character symbols transmitted from a terminal device;
performing preprocessing on the input data to generate preprocessed text data;
constructing a prompt data structure comprising the preprocessed text data and control parameters, and transmitting the prompt data structure to a generative neural network model to obtain response data comprising a generated text sequence;
performing correction processing on the generated text sequence to generate corrected text data;
storing the corrected text data in a storage device in association with the input data and management data relating to the prompt data structure; and
transmitting the corrected text data to the terminal device via the packet-switched network.
